(19) United States
(12) Patent Application Publication
(10) Pub. No.: US 2023/0320548 A1
(43) Pub. Date: Oct. 12, 2023

(54) NOZZLE UNIT, ROBOT CLEANER INCLUDING SAME, AND CONTROL METHOD THEREFOR

(71) Applicant: LG ELECTRONICS INC., Seoul (KR)

(72) Inventors: Changhwa SUN, Seoul (KR); Seungyeop LEE, Seoul (KR); Sangchul LEE, Seoul (KR); Jungmin KO, Seoul (KR)

(21) Appl. No.: 18/017,326

(22) PCT Filed: Nov. 27, 2020
(86) PCT No.: PCT/KR2020/017075

§ 371 Date: Jan. 20, 2023

(30) Foreign Application Priority Data
Jul. 23, 2020 (KR) 10-2020-0091871

(51) Int. Cl. A47L 9/28; A47L 7/00; A47L 9/04

(52) U.S. Cl. CPC A47L 9/0477; A47L 7/0066; A47L 9/0433; A47L 9/2805; A47L 9/2847; A47L 2201/06

(57) ABSTRACT

Disclosed are a nozzle unit, a robot cleaner including same, and a control method therefor. The nozzle unit according to an embodiment of the present invention comprises a plurality of brushes that rotate in different directions. One of the plurality of brushes rotates such that waste such as hair attaches and collects thereon. Another one of the plurality of brushes rotates such that the attached waste such as hair becomes separated. The above processes are performed simultaneously. Accordingly, waste such as hair present on a floor surface can be easily collected and separated. Consequently, user convenience can be enhanced.

### TECHNICAL FIELD

The present disclosure relates to a nozzle part and a robot cleaner including the same, and more specifically, to a nozzle part having a structure capable of effectively collecting substances such as hair or fiber that is easily adhered but is not easily separated, and a robot cleaner including the same.

### BACKGROUND ART

A robot cleaner refers to a device capable of independently performing a cleaning operation according to a preset method, without requiring a user’s manual operation. The robot cleaner may have an operation time and an operation method set in advance.

The robot cleaner provides various conveniences such as that the user does not need to directly perform cleaning, and that the operation mode and operation time can be arbitrarily set. Accordingly, in recent years, the demand for a robot cleaner has been increased.

The robot cleaner drives indoors according to a preset method and sucks dust, small trash or the like existing on the floor. To this end, the robot cleaner includes a motor that forms suction power, a dust bin that stores sucked dust or small trash, and a filter that purifies and discharges air sucked in the dust bin.

The trash collected by the robot cleaner may have many forms. For example, the trash may include hair that has been removed from a human body, fiber strands separated from clothes, and the like.

With the trend of decreasing the number of members constituting households, such as single-person households, households with companion animals are increasing. In the above case, by the way, companion animals have more fur that falls out more easily than humans.

The above-described trash such as hair, fiber strands, or companion animal hair has a property of being easily adhered to an object having a rough surface by electrostatic attraction. At the same time, the trash has a property of not being easily separated from a surface of the adhered object.

Therefore, in everyday life, when the trash adheres to a surface of an object made of a fibrous material such as a carpet or a rug, it is not easy to separate it. Even when the trash is collected during housework or while the robot cleaner drives on a surface such as a carpet or a rug, it is difficult to separate the trash from the robot cleaner.

Accordingly, not only the user’s convenience is deteriorated, but there is also a concern that the robot cleaner may malfunction or be damaged by the trash adhered to the robot cleaner.

Korean Patent Document No. 10-1981827 discloses a cleaning device for a nozzle of a vacuum cleaner. More specifically, it discloses a cleaning device for a nozzle of a vacuum cleaner including a socket for accommodating a vacuum cleaner nozzle, and a cleaning member disposed in the socket to remove articles entangled therewith while a rotatable member rotates.

However, the cleaning device for the nozzle of this type of vacuum cleaner is disposed in a charging stand for charging the vacuum cleaner. Accordingly, there is an inconvenience in that the user must place the vacuum cleaner on the charging stand and then operate the vacuum cleaner again after completing the use of the vacuum cleaner.

Korean Patent Publication No. 10-2020-0028580 discloses a pet comb capable of sucking and removing hair and a vacuum cleaner including the same. Specifically, it discloses a pet comb including a roll comb part that combs the fur of a pet inside a body case and a rake part that removes fur stuck in the roll comb portion and a vacuum cleaner including the same.

However, this type of pet comb and a vacuum cleaner including the same have a limitation in that they are applicable only to a handy type cleaner other than a robot cleaner or a large cleaner due to their use.

In addition, since both the roll comb part and the rake part are provided in a rake shape, there is also a limitation that it is difficult to remove hair tangled in each rake.
Korean Patent No. 10-1981827 (May 23, 2019)
Korean Patent Publication No. 10-2020-0028580 (Apr. 8, 2020)

### DISCLOSURE OF INVENTION

### Technical Problem

An aspect of the present disclosure is to provide a nozzle part having a structure capable of solving the foregoing problems, a robot cleaner including the same, and a control method thereof.

First, an aspect of the present disclosure is to provide a nozzle part having a structure capable of easily collecting trash in the form of hair or fiber scattered indoors, a robot cleaner including the same, and a control method thereof.

Furthermore, an aspect of the present disclosure is to provide a nozzle part having a structure capable of easily capturing the collected trash in the form of hair or fiber, a robot cleaner including the same, and a control method thereof.

In addition, an aspect of the present disclosure is to provide a nozzle part having a structure capable of easily discharging the trash in the form of hair or fiber, a robot cleaner including the same, and a control method thereof.

Moreover, an aspect of the present disclosure is to provide a nozzle part having a structure that does not interfere with the driving of a robot cleaner by a member provided to collect trash in the form of hair or fiber, a robot cleaner including the same, and a control method thereof.

Besides, an aspect of the present disclosure is to provide a nozzle part having a structure capable of minimizing the number of components that provide power to a member for achieving the above object, a robot cleaner including the same, and a control method thereof.

Furthermore, an aspect of the present disclosure is to provide a nozzle part having a structure capable of simplifying the structure of the member for achieving the above object, a robot cleaner including the same, and a control method thereof.

In addition, an aspect of the present disclosure is to provide a nozzle part having a structure that is applicable to other types of robot cleaners as well as achieving the above object, a robot cleaner including the same, and a control method thereof.

### Solution to Problem

In order to achieve the foregoing objectives, the present disclosure provides a nozzle part, including a frame; a first brush rotatably coupled to the frame to extend in one direction; a second brush located adjacent to the first brush to extend in said one direction, and rotatably coupled to the frame; and a removal member coupled to the frame, and located adjacent to at least either one of the first brush and the second brush, wherein the removal member extends along said one direction in which the first brush and the second brush extend, and the first brush and the second brush are respectively partially in contact with the removal member to rotate in different directions to each other.

Furthermore, the first brush and the second brush of the nozzle part may be defined in a circular cross section having a predetermined curvature, and the cross section of the removal member may be defined in a round shape to be convex in a direction opposite to the first brush or the second brush.

Furthermore, the cross section of the removal member of the nozzle part may be defined to have a center located on the central axis of the first brush or the second brush, with a curvature that is the same as that of the first brush and the second brush.

Furthermore, the removal member of the nozzle part may include a first removal member located adjacent to the first brush between the first brush and the second brush to be in contact with the first brush; and a second removal member located adjacent to the second brush to be in contact with the second brush.

Furthermore, the first brush and the second brush of the nozzle part may respectively have a cylindrical shape extending in said one direction, and the first brush may include a first adhesive member constituting part of an outer circumference of the first brush, which is formed of a material having a predetermined roughness; and a first exposed portion constituting the remaining part of the outer circumference of the first brush, which is exposed to the outside, and the second brush may include a second adhesive member constituting part of an outer circumference of the second brush, which is formed of a material having a predetermined roughness; and a second exposed portion constituting the remaining part of the outer circumference of the second brush, which is exposed to the outside.

Furthermore, the removal member may be formed of a material having a relatively lower roughness than those of the first adhesive member and the second adhesive member.

Furthermore, the nozzle part may include a sensor part located adjacent to either one of the first brush and the second brush to sense information related to the rotation of the either one brush of the first brush and the second brush, wherein the sensor part includes a magnetic body coupled to the either one brush of the first brush and the second brush to rotate together with the either one brush; and a sensing unit coupled to the frame adjacent to the magnetic body to sense the strength and direction of a magnetic field generated by the rotation of the magnetic body.

Furthermore, the nozzle part may include a controller connected to the sensor part to be electrically conductive so as to receive the sensed information, wherein the controller includes a rotation information calculation module that calculates rotation information on the rotation of the either one brush using the received information; an operation information calculation module connected to the rotation information calculation module to be electrically conductive so as to calculate operation information on the operation of a power part using the calculated rotation information; and a power part control module connected to the operation information calculation module to be electrically conductive so as to control the operation of the power part using the calculated operation information.

Furthermore, the nozzle part may include a first main gear coupled to the first brush to rotate together with the first brush; a second main gear coupled to the second brush to rotate together with the second brush; a first sub-gear rotatably coupled to the frame, and coupled to a rotationally operated power part, and gear-fitted to either one main gear of the first main gear and the second main gear; and a second sub-gear rotatably coupled to the frame, and gear-coupled to the other one main gear of the first main gear and the second main gear, and the first sub-gear, respectively.

In addition, the present disclosure provides a robot cleaner, including a body part; a dust bin detachably coupled to the body part, and defined with a space therein; a nozzle housing detachably coupled to the body part, an inner space of which communicates with the space of the dust bin; and a nozzle part rotatably accommodated in the nozzle housing, and partially exposed to an outside of the nozzle housing, wherein the nozzle part includes a frame coupled to the nozzle housing; a first brush rotatably coupled to the frame to extend in one direction; a second brush located adjacent to the first brush to extend in said one direction, and rotatably coupled to the frame; and a removal member coupled to the frame, and located adjacent to at least either one of the first brush and the second brush to extend along said one direction in which the first brush and the second brush extend, wherein the removal member includes a first removal member located adjacent to the first brush between the first brush and the second brush to be in contact with the first brush; and a second removal member located adjacent to the second brush to be in contact with the second brush, and wherein the first brush and the second brush are rotated in different directions to each other.

Furthermore, the first brush and the second brush of the robot cleaner may be defined in a circular cross section having a predetermined curvature, and the cross section of the removal member may be defined in a round shape to be convex in a direction opposite to the first brush and the second brush, and defined with a curvature that is the same as that of the first brush and the second brush, and the first removal member and the second removal member may partially surround outer circumferences of the first brush and the second brush, respectively.

Furthermore, the first brush and the second brush of the robot cleaner may include a first adhesive member and a second adhesive member formed of a material having a predetermined roughness, respectively, and the removal member may formed of a material having a lower roughness than those of the first adhesive member and the second adhesive member.

Furthermore, the robot cleaner may include a magnetic body coupled to the either one brush of the first brush and the second brush to rotate together with the either one brush; a sensing unit coupled to the frame adjacent to the magnetic body to sense information on the strength and direction of a magnetic field generated by the rotation of the magnetic body; and a controller connected to the sensing unit to be electrically conductive so as to receive the sensed information, and calculate operation information on the operation of the power part using the received information, and control the operation of the power part according to the calculated operation information.

Furthermore, the robot cleaner may include a first main gear coupled to the first brush to rotate together with the first brush; a second main gear coupled to the second brush to rotate together with the second brush; a first sub-gear rotatably coupled to the frame, and coupled to a rotationally operated power part, and gear-fitted to either one main gear of the first main gear and the second main gear; and a second sub-gear rotatably coupled to the frame, and gear-fitted to the other one main gear of the first main gear and the second main gear, and the first sub-gear, respectively.

Moreover, the present disclosure provides a method of controlling a robot cleaner, and the method may include (a) allowing a sensor part to sense information on the rotation of a brush; (b) allowing a controller to calculate rotation information using the sensed information; (c) allowing the controller to calculate operation information using the calculated rotation information; (d) allowing the controller to control a power part according to the calculated operation information; and (e) operating the brush according to the calculated operation information.

Furthermore, said step (a) in the method of controlling the robot cleaner may include (a1) allowing the power part to rotate the brush and a magnetic body coupled to the brush; (a2) allowing a sensing unit to sense information on the number of rotations of the magnetic body and information on a rotation direction thereof; and (a3) allowing the sensing unit to transmit the sensed information on the number of rotations of the magnetic body and the information on the rotation direction to the controller, wherein information on the rotation of the brush includes information on the number of rotations of the magnetic body and information on the rotation direction.

Furthermore, said step (b) in the method of controlling the robot cleaner may include (b1) allowing a rotation information calculation module to receive the sensed information on the rotation of the brush; (b2) allowing the rotation information calculation module to compare the information on the rotation of the brush with preset reference rotation information to calculate the rotation information; and (b3) allowing the rotation information calculation module to transmit the calculated rotation information to an operation information calculation module.

Furthermore, said step (c) in the method of controlling the robot cleaner may include (c1) allowing an operation information calculation module to receive the calculated rotation information; (c2) allowing the operation information calculation module to calculate the operation information using the calculated rotation information; and (c3) allowing the operation information calculation module to transmit the calculated operation information to the power part control module.

Furthermore, said step (d) in the method of controlling the robot cleaner may include (d1) allowing a power part control module to receive the calculated operation information; and (d2) allowing the power part control module to control the rotation of the power part according to the calculated operation information.

Furthermore, said step (e) in the method of controlling the robot cleaner may include (e1) operating the power part according to the calculated operation information; (e2) operating the brush coupled to the power part according to the calculated operation information; and (e3) allowing the sensor part to sense information on the rotation of the brush.

### Advantageous Effects of Invention

According to an embodiment of the present disclosure, the following effects may be achieved.

First, a first brush and a second brush is provided in the nozzle part. The first and second brushes extend in one direction, and first and second adhesive members formed of a material such as felt having high roughness are respectively provided on outer circumferences thereof.

In other words, the first and second adhesive members constitute a part of the outer circumference surfaces of the first and second brushes. The first and second brushes are partially exposed to an outside of the nozzle housing.

When the robot cleaner is operated, the first and second adhesive members roll along a floor surface to be cleaned. Due to the characteristics of the material and shape of the first and second adhesive members, trash such as hair staying on the floor surface is easily adhered to the first and second adhesive members.

Accordingly, trash such as fur existing in a region where the robot cleaner has passed while being driven may be easily collected.

Furthermore, a removal member is provided in the nozzle part. The removal member is located adjacent to the first and second brushes to be in contact with the first and second brushes. The removal member is disposed at a lower frame to partially surround an outer circumference of the brush.

Trash such as hair adhered to the first and second adhesive members provided on the first and second brushes may be separated while in contact with the removal member, and removed into an inner space of the nozzle housing.

Accordingly, the collected trash such as fur may be easily collected in a dust bin through an inner space of the nozzle housing and body part without any additional operation.

Furthermore, the dust bin is detachably coupled to the body part. An inner space of the dust bin communicates with an inner space of the body part. Through the foregoing process, trash such as fur scattered on the floor surface is collected and then moved and accommodated in the dust bin.

Accordingly, a user may separate only the dust bin to easily discharge the collected trash such as fur.

Furthermore, the first brush and the second brush are rotated in different directions. The first brush and the second brush may be rotated alternately and repeatedly in different directions.

Specifically, a sensor part is provided adjacent to at least one of the first and second brushes. The sensor part includes a magnetic body that is rotated together with the first and second brushes and a sensing unit that senses a magnetic field formed by the rotation of the magnetic body.

Information sensed by the sensor part is transmitted to the controller. The controller calculates rotation information using the sensed information. The controller calculates operation information for controlling a power part and the resultant operation of the first and second brushes according to the calculated rotation information.

For an example, after one end portion of either one of the first and second adhesive members provided on the first and second brushes, respectively, is in contact with one end portion of the removal member, the controller calculates whether the other end portion of the either one thereof is in contact with the other end portion of the removal member.

According to the calculation result, the controller calculates operation information for maintaining a current rotation direction or changing the rotation direction. Accordingly, the first and second brushes are rotated in opposite directions to each other, but controlled to alternately rotate in a clockwise or counterclockwise direction.

As a result, either one of the first and second brushes is rotated along a direction in which the robot cleaner drives. Accordingly, even when a brush for separating trash such as fur adhered thereto is operated, the driving of the robot cleaner may not be disturbed.

Furthermore, a main gear and a sub-gear are coupled to the first and second brushes. The main gear is gear-coupled to the power part and the sub-gear. The sub-gear is gear-coupled to a teeth part disposed on an inner circumference of the main gear and the support part.

When the power part is operated, the sub-gear and the main gear gear-coupled thereto are rotated together. At this time, the first and second brushes coupled to the main gear are also rotated together.

As a result, when the sub-gear is rotated by a single number of the power part, the main gear and the first and second brushes coupled thereto may also be rotated by various combinations. Accordingly, the number of power sources required to rotate the first and second brushes may be minimized.

Moreover, through the foregoing configuration, the first and second brushes may be rotated simultaneously by a single power part. Accordingly, the configuration of the nozzle part may be defined simply.

In addition, the nozzle housing accommodating the nozzle part is detachably coupled to the body part. Therefore, the foregoing effects may be achieved only by separating the nozzle housing from the body part and coupling it to the body part of another robot cleaner.

Accordingly, the versatility of the nozzle part may be improved. In addition, the user may purchase only the nozzle part separately without purchasing an entire robot cleaner to use it for the robot cleaner previously used.

### BRIEF DESCRIPTION OF DRAWINGS

FIG. 1 is a perspective view illustrating a robot cleaner according to an embodiment of the present disclosure.

FIG. 2 is a perspective view illustrating the robot cleaner of FIG. 1 at a different angle.

FIG. 3 is a plan view illustrating the robot cleaner of FIG. 1.

FIG. 4 is a bottom view illustrating the robot cleaner of FIG. 1.

FIG. 5 is a partial cut-away side view illustrating the robot cleaner of FIG. 1.

FIG. 6 is a perspective view illustrating a nozzle part provided in the robot cleaner of FIG. 1.

FIG. 7 is a perspective view illustrating the nozzle part of FIG. 6 at a different angle.

FIG. 8 is a perspective view illustrating the nozzle part of FIG. 6.

FIG. 9 is a perspective view illustrating the nozzle part of FIG. 6 at a different angle.

FIGS. 10 through 12 are partial cut-away perspective views illustrating the nozzle part of FIG. 6.

FIGS. 13 and 14 are partial cut-away side views illustrating the nozzle part of FIG. 6.

FIGS. 15 and 16 are perspective views illustrating an operation process of the nozzle part of FIG. 6.

FIG. 17 is a block diagram illustrating a configuration for implementing a control method of a robot cleaner according to an embodiment of the present disclosure.

FIG. 18 is a flowchart illustrating a flow of a method for controlling a robot cleaner according to an embodiment of the present disclosure.

FIG. 19 is a flowchart illustrating a detailed flow of step S100 in the method of controlling the robot cleaner according to the embodiment of FIG. 18.

FIG. 20 is a flowchart illustrating a detailed flow of step S200 in the method of controlling the robot cleaner according to the embodiment of FIG. 18.

FIG. 21 is a flowchart illustrating a detailed flow of step S300 in the method of controlling the robot cleaner according to the embodiment of FIG. 18.

FIG. 22 is a flowchart illustrating a detailed flow of step S400 in the method of controlling the robot cleaner according to the embodiment of FIG. 18.

FIG. 23 is a flowchart illustrating a detailed flow of step S500 in the method of controlling the robot cleaner according to the embodiment of FIG. 18.

FIGS. 24 and 25 are conceptual views illustrating a process of collecting trash such as fur by a robot cleaner according to an embodiment of the present disclosure.

### MODE FOR THE INVENTION

Hereinafter, a nozzle part according to an embodiment of the present disclosure and a robot cleaner including the same will be described in detail with reference to the accompanying drawings.

In the following description, the description of some components may be omitted to clarify the features of the present disclosure.

### 1. Definition of Terms

In case where an element is “connected” or “linked” to the other element, it may be directly connected or linked to the other element, but it should be understood that any other element may be existed therebetween.

On the contrary, in case where an element is “directly connected” or “directly linked” to the other element, it should be understood that any other element is not existed therebetween.

Unless clearly used otherwise, a singular expression used in the present disclosure may include a plural expression.

The term “dust” used in the following description refers to fine-sized particles, dust, etc. existing in an environment such as indoors where a robot cleaner is operated.

The term “small trash” used in the following description refers to trash of a size that is larger than dust but can be collected by the robot cleaner.

The term “fur” used in the following description refers to a fine thread-like material that has been removed from animals, including humans. The fur may be body hair that has been removed from a human body, hair on the head, or body hair that has been removed from an animal body.

The term “fiber” used in the following description refers to any fine thread-like material except for the fur. In one embodiment, the fiber may be a material that has been removed from clothing, bedding, furniture, and miscellaneous goods.

In the following description, hair and fiber are collectively referred to as “fur (F) or the like.”

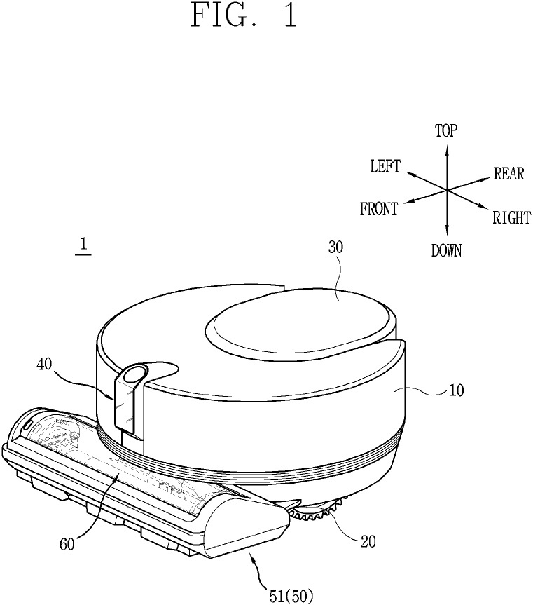

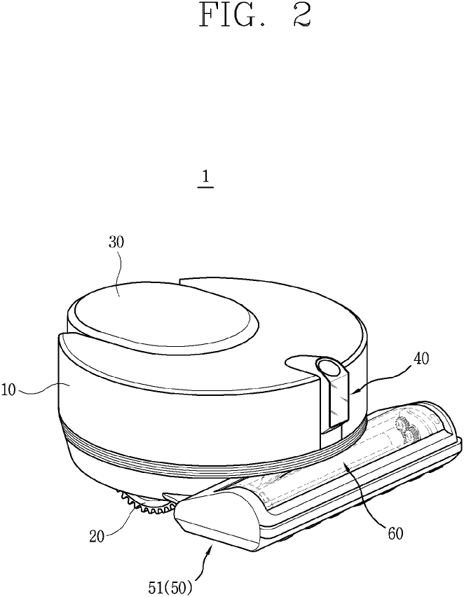

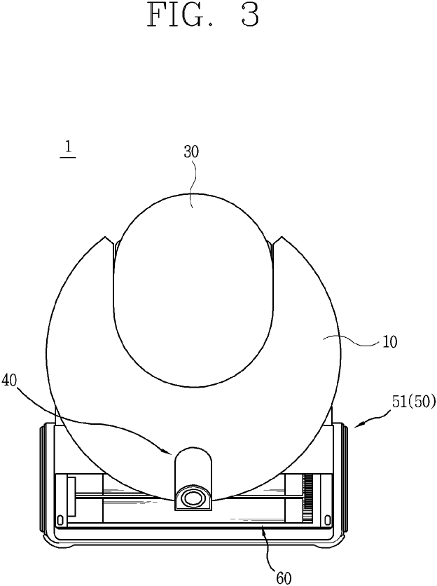

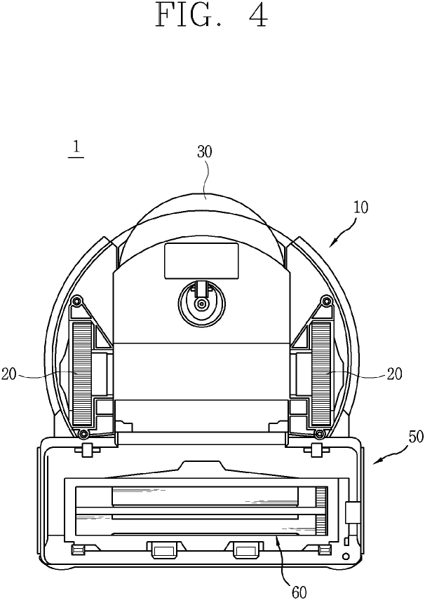

The terms “front side”, “rear side”, “left side”, “right side”, “top side” and “bottom side” used in the following description will be understood with reference to a coordinate system illustrated in FIG. 1.

### 2. Description of Configuration of Robot Cleaner 1 According To Embodiment of Present Disclosure

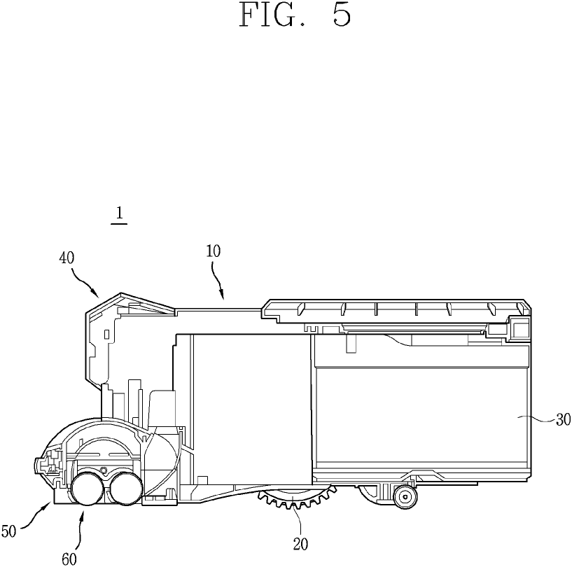

Referring to FIGS. 1 and 5, a robot cleaner 1 according to an embodiment of the present disclosure includes a body part 10, a driving part 20, a dust bin 30, an external sensor part 40, a nozzle housing 50, and a nozzle part 60.

Hereinafter, each configuration of the robot cleaner 1 according to an embodiment of the present disclosure will be described with reference to the accompanying drawings, but the nozzle part 60 will be described as a separate paragraph.

### Description of Body Part 10

The body part 10 forms an outer shape of the robot cleaner 1. The body part 10 may accommodate components for the robot cleaner 1 to perform a cleaning operation in a space accommodated therein.

The body part 10 may collide with various obstacles provided in a region where the robot cleaner 1 is driven, for example, indoors. Therefore, the body part 10 is preferably formed of a material of high rigidity to prevent damage due to a collision.

In addition, the body part 10 is preferably formed of a lightweight material. This is to reduce power required for the driving of the robot cleaner 1.

In one embodiment, the body part 10 may be formed of a synthetic resin such as reinforced plastic.

A user interface may be provided outside the body part 10. The user may manipulate the user interface to control the operation of the robot cleaner 1. Furthermore, the user interface may display information on the robot cleaner 1 and the state of a region where the robot cleaner 1 is driven.

An inner space of the body part 10 may communicate with the outside. Air or small trash collected while the robot cleaner 1 is driven may flow into the dust bin 30 that is detachably coupled through an inner space of the body part 10. In addition, air introduced together with dust or small trash may be discharged to an outside of the body part 10.

Various sensors may be provided in the body part 10. In other words, in addition to the external sensor part 40 which will be described later, the body part 10 may be provided with a gyro sensor or the like for sensing an inclination of the floor surface (G).

In the illustrated embodiment, the body part 10 has a circular cross section, and is provided in a disk shape having a predetermined height in a vertical direction. Accordingly, when the robot cleaner 1 collides with various obstacles while being driven, the body part 10 may rotate and drive in various directions.

A nozzle housing 50 and a nozzle part 60 accommodated in the nozzle housing 50 are detachably coupled to the body part 10. An inner space of the nozzle housing 50 may communicate with an inner space of the body part 10 and the dust bin 30.

Accordingly, trash (H) such as fur collected by the nozzle part 60 may be introduced and collected in the dust bin 30 through an inner space of the body part 10.

The driving part 20 is rotatably coupled to a lower side of the body part 10.

The driving part 20 provides power for moving the robot cleaner 1. In addition, the driving part 20 allows the robot cleaner 1 to be rotated to change the driving direction.

The driving part 20 is located at a lower side of the robot cleaner 1. The driving part 20 is rotatably coupled to a lower side of the body part 10.

The driving part 20 may be provided in a form capable of being rotated to move forward or backward. In the illustrated embodiment, the driving part 20 is provided in the form of a wheel.

A plurality of driving parts 20 may be provided. In the illustrated embodiment, the driving part 20 is provided on the left and right sides, respectively, at a lower side of the body part 10. The rotational speed and rotation direction of each driving part 20 positioned on each side may be controlled independently of each other.

Accordingly, the robot cleaner 1 may move forward, backward, rotate left or right.

Although not shown, the driving part 20 may be coupled to a power device (not shown). The power device (not shown) may be provided in the form of a motor that rotates the driving part 20 by receiving an electric signal.

In one embodiment, a plurality of power devices (not shown) may be provided, and coupled to a plurality of driving parts 20, respectively. Accordingly, the plurality of driving parts 20 may be controlled independently of each other.

The dust bin 30 stores the collected trash while the robot cleaner 1 is driven. In one embodiment, the dust bin 30 may accommodate trash (H) such as fur.

A predetermined space is defined inside the dust bin 30. The space communicates with a space disposed inside the body part 10. The trash collected through the nozzle part 60 may pass through the space disposed inside the body part 10 to enter an inside of the dust bin 30.

The dust bin 30 is detachably coupled to the body part 10. The user may release the dust bin 30 from the body part 10 to easily remove trash accommodated in the dust bin 30.

The dust bin 30 may be formed of a transparent material. This is to allow the user to visually recognize an amount of trash accommodated in the dust bin 30 and easily determine the discharge timing of trash.

Alternatively, a sensor (not shown) may be provided in the dust bin 30. In one embodiment, the sensor (not shown) may sense the mass or volume of trash accommodated in an inner space of the dust bin 30. The sensed mass or volume may be transmitted to the user in the form of visualization information or auditory information to allow the user to easily recognize the discharge timing of trash.

The external sensor part 40 senses information on a path on which the robot cleaner 1 is driven.

The external sensor part 40 may be located in a direction in which the robot cleaner 1 is to be driven. In the illustrated embodiment, the external sensor part 40 is located at a front side of the body part 10 to sense information about an environment at a front side of the robot cleaner 1.

The external sensor part 40 may be provided in an arbitrary form capable of detecting information on the environment of a path on which the robot cleaner 1 is driven or to be driven. In the illustrated embodiment, the external sensor part 40 is provided as a camera capable of sensing image information.

Although not shown, the external sensor part 40 may further include an infrared sensor or the like for sensing a distance to an obstacle.

The nozzle housing 50 is detachably coupled to a lower side of the external sensor part 40, that is, at a lower side of the front of the body part 10.

The nozzle housing 50 accommodates the nozzle part 60. As the robot cleaner 1 is driven, trash collected by the nozzle part 60, particularly, trash (H) such as fur may be introduced into a space inside the body part 10 and the dust bin 30 through the nozzle housing 50.

The nozzle housing 50 is located at a lower side of the front of the body part 10. When the driving part 20 is rotated, a lower side of the nozzle housing 50 may be in contact with the floor surface (G) or spaced apart by a predetermined distance to move together with the body part 10.

A space is defined inside the nozzle housing 50. The nozzle part 60 is accommodated in the space. As will be described later, the nozzle part 60 includes a frame 100, a brush 200 rotatably coupled to the frame 100, and a removal member 300. The brush 200 and the removal member 300 of the nozzle part 60 may be rotated in an inner space of the nozzle housing 50.

The nozzle housing 50 is detachably coupled to the body part 10. When the nozzle housing 50 and the body part 10 are coupled to each other, the inner space of the nozzle housing 50 communicates with the inner space of the body part 10. Accordingly, the inner space of the nozzle housing 50 may communicate with the dust container 30.

The nozzle housing 50 is coupled to the body part 10 and moved together, and may have any shape capable of accommodating the nozzle part 60 therein. In the illustrated embodiment, the nozzle housing 50 has a polygonal columnar shape that extends long in a left-right direction, and protrudes upward with different inclination angles in the front and rear directions.

The nozzle housing 50 may collide with various obstacles provided in a region where the robot cleaner 1 is driven, for example, indoors. It is because the nozzle housing 50 is coupled to the body part 10 to be exposed to an outside of the body part 10. Therefore, the nozzle housing 50 is preferably formed of a material of high rigidity to prevent damage due to a collision.

Furthermore, the nozzle housing 50 is preferably formed of a lightweight material. This is to reduce power required for the driving of the robot cleaner 1.

In one embodiment, the nozzle housing 50 may be formed of a synthetic resin such as reinforced plastic.

In the illustrated embodiment, the nozzle housing 50 includes an outer housing 51, an inner housing 52 and a communication part 53.

The outer housing 51 defines an outer side of the nozzle housing 50. The outer housing 51 is exposed to an outside of the nozzle housing 50.

A predetermined space is defined inside the outer housing 51. The inner housing 52 and the nozzle part 60 accommodated in the inner housing 52 are accommodated in the space. The space communicates with a space disposed inside the body part 10. The communication is achieved by the communication part 53.

The inner housing 52 is located inside the outer housing 51.

The inner housing 52 defines an inner side of the nozzle housing 50. The inner housing 52 is not exposed to the outside.

A space is defined inside the inner housing 52. The nozzle part 60 is accommodated in the space. The brush 200 and the removal member 300 of the nozzle part 60 may be rotated while being accommodated in the inner housing 52.

The nozzle part 52 may be coupled to the inner housing 60. Specifically, the frame 100 of the nozzle part 60 may be coupled to the inner housing 52.

An opening part is disposed at one side of the inner housing 52, at a lower side in the illustrated embodiment. The nozzle part 60 accommodated in the inner housing 52 may be exposed to an outer side of the inner housing 52 through the opening part. Accordingly, when the robot cleaner 1 is driven, various types of trash placed on the floor surface (G) may be collected by the nozzle part 60.

The space defined inside the inner housing 52 communicates with the communication part 53. Various types of trash collected by the nozzle part 60 may pass through the communication part 53 to be introduced into the inner space of the body part 10 and the dust container 30.

The communication part 53 communicates an inner space of the outer housing 51 and an inner space of the inner housing 52 with an inner space of the body part 10.

The communication part 53 may be located in the outer housing 51. The communication part 53 is located on one side facing the body part 10, at upper side of the rear in the illustrated embodiment.

The communication part 53 may be detachably coupled to the body part 10. By the coupling, the nozzle housing 50 and the body part 10 may be detachably coupled to each other.

### 3. Description of Nozzle Part 60 According to Embodiment of Present Disclosure

Referring back to FIGS. 1 and 5, the robot cleaner 1 according to an embodiment of the present disclosure includes a nozzle part 60.

The nozzle part 60 is rotated as the robot cleaner 1 is operated to collect various types of trash located on the floor surface (G) in a region where the nozzle part 60 is exposed.

The nozzle part 60 may be moved together as the robot cleaner 1 is moved. Accordingly, the nozzle part 60 may collect trash in various regions.

The nozzle part 60 may be accommodated in the nozzle housing 50, and exposed toward the floor surface (G). When the robot cleaner 1 is driven, the nozzle part 60 is driven while being in contact with the floor surface (G) or being separated by a predetermined distance.

The nozzle part 60 may be rotated. Accordingly, various types of trash located on the floor surface (G) may be collected by the nozzle part 60, and collected in the dust bin 30 through the nozzle housing 50.

In this specification, the description will be made on the premise that the nozzle part 60 is rotated to collect trash (H) such as fur.

### Description of Components of Nozzle Part 60

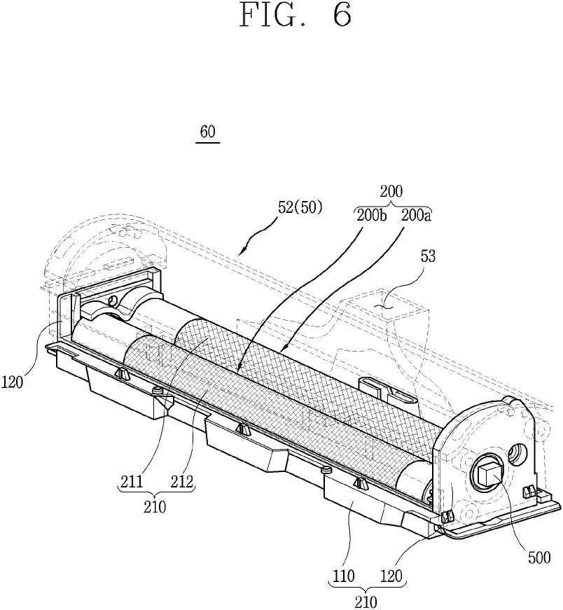

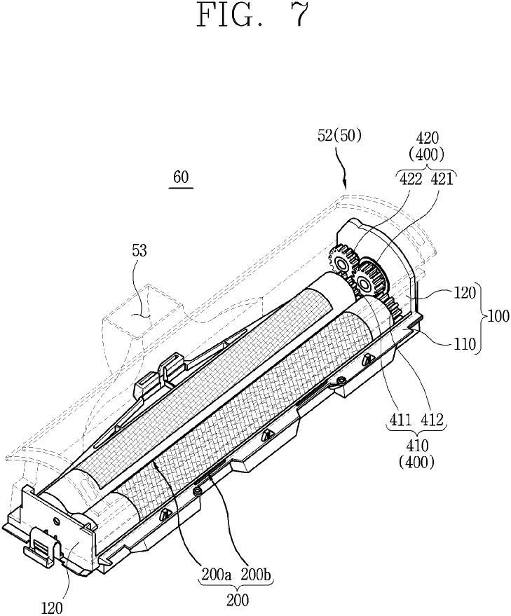

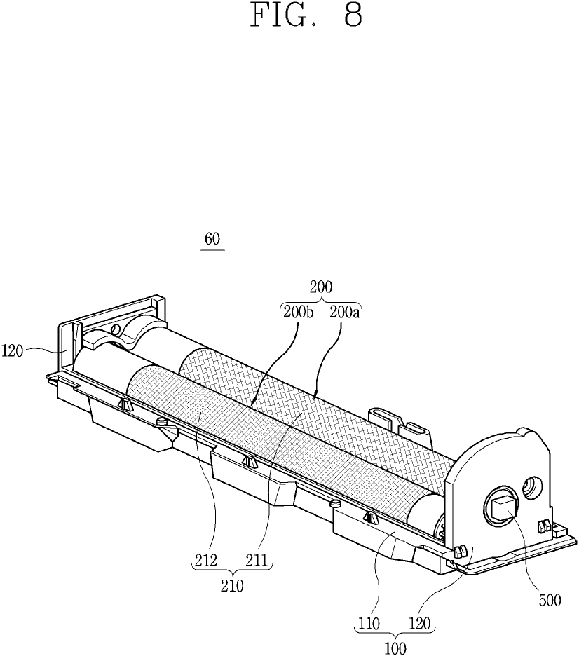

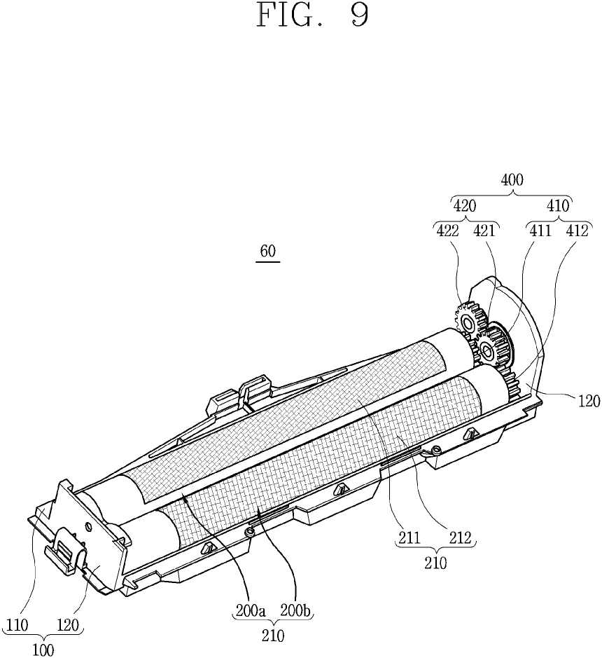

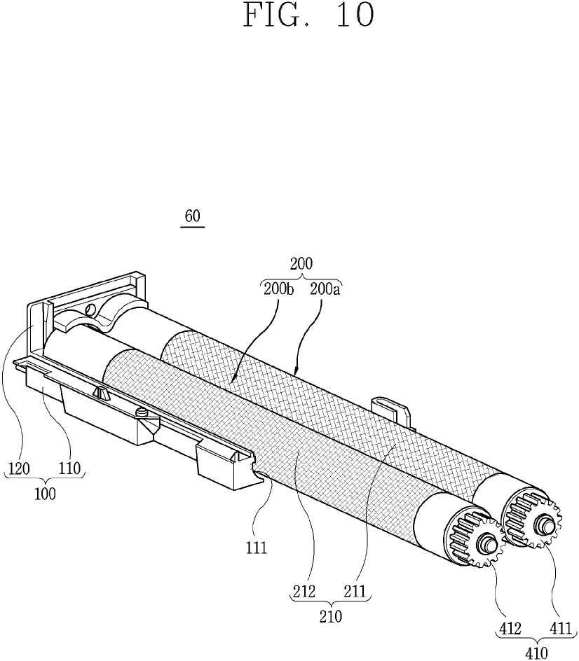

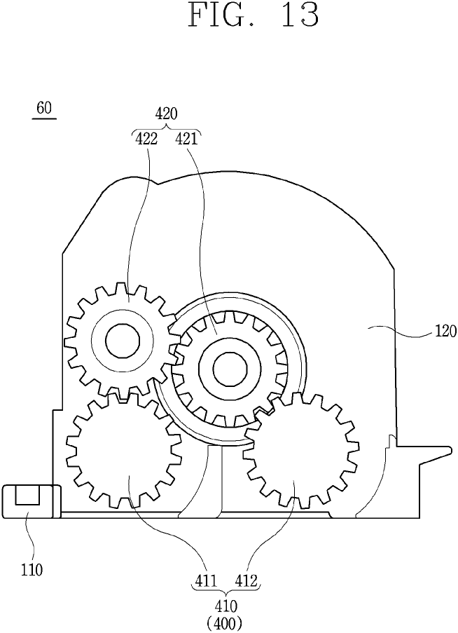

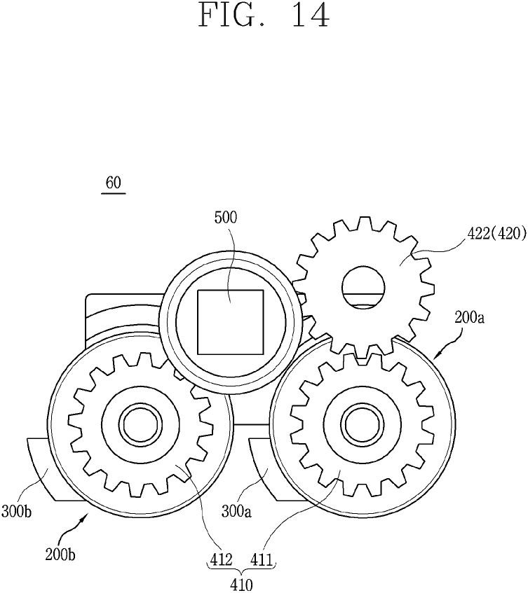

Hereinafter, components of the nozzle part 60 according to an embodiment of the present disclosure will be described in detail with reference to FIGS. 6 through 14.

In the illustrated embodiment, the nozzle part 60 includes a frame 100, a brush 200, a removal member 300, a gear part 400, a power part 500, a sensor part 600, and a controller 700.

The frame 100 is a portion in which the nozzle part 60 is coupled to the nozzle housing 50. In addition, the frame 100 rotatably supports the brush 200 and the removal member 300.

The frame 100 may be formed of a lightweight and high rigid material. In one embodiment, the frame 100 may be formed of a synthetic resin material such as reinforced plastic.

The frame 100 defines part of the outer shape of the nozzle part 60. In the illustrated embodiment, the frame 100 defines lower, left and right sides of the nozzle part 60.

In the illustrated embodiment, the frame 100 includes a lower frame 110, and a side frame 120.

The lower frame 110 defines a lower side of the frame 100. The lower frame 110 partially surrounds a lower side of the brush 200.

The lower frame 110 may be defined in a shape corresponding to the shape of the brush 200. In the illustrated embodiment, the brush 200 has a cylindrical shape extending in a left-right direction, and the lower frame 110 may also be provided in a plate shape extending in a left-right direction.

An opening part is disposed inside the lower frame 110. The opening part may be disposed to pass through upper and lower portions of the lower frame 110. Part of the brush 200, in the illustrated embodiment, part of the lower side may be exposed to a lower side of the lower frame 110 through the opening part. Accordingly, the brush 200 may be exposed to an outside of the nozzle housing 50.

The lower frame 110 includes a removal member coupling surface 111.

The removal member coupling surface 111 is a portion provided with the removal member 300 for separating trash (H) such as fur adhered to the adhesive member 210 of the brush 200.

The removal member coupling surface 111 may partially support the brush 200. In other, words, the brush 200 may be rotated in a state in contact with the removal member coupling surface 111. Accordingly, trash (H) such as fur adhered to the adhesive member 210 of the brush 200 may be effectively separated by the removal member 300.

The removal member coupling surface 111 is disposed inside the lower frame 110. Specifically, the removal member coupling surface 111 is disposed inside the lower frame 110, at a position facing the brush 200.

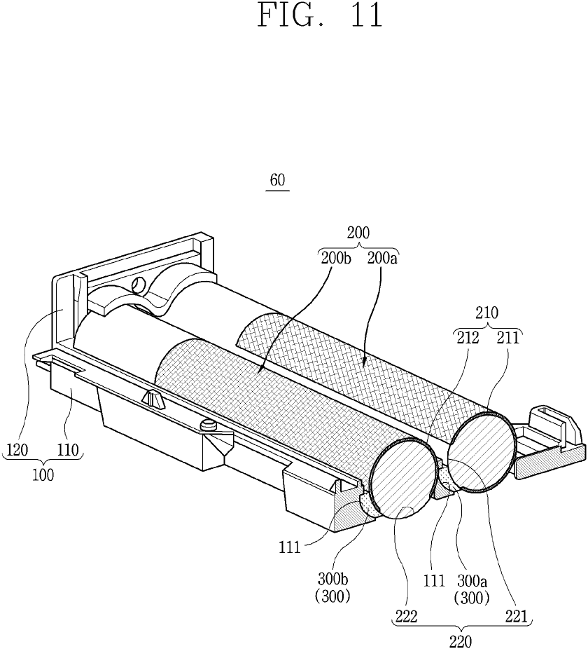

As best illustrated in FIG. 11, a plurality of removal member coupling surfaces 111 may be disposed. The plurality of removal member coupling surfaces 111 are disposed to surround the plurality of brushes 200, respectively, in a direction different from an extension direction of the brush 200, from a front side in the illustrated embodiment.

The removal member coupling surface 111 may be defined to be round. The removal member coupling surface 111 is disposed to be convex in a direction opposite to the brush 200, toward a front side in the illustrated embodiment.

In this case, a curvature of the removal member coupling surface 111 may be defined to correspond to that of an outer circumference of the brush 200. In an embodiment, the center of the removal member coupling surface 111 may be located at the central axis of the brush 200.

The removal member coupling surface 111 may be defined in an arc shape. In this case, the removal member coupling surface 111 may have an arc shape whose center is located at the central axis of the brush 200 and whose central angle is an acute angle.

The removal member coupling surface 111 may be recessed in a direction opposite to the brush 200 on one surface of the lower frame 110 facing the brush 200. Accordingly, a space to which the removal member 300 can be coupled may be defined between the brush 200 and the removal member coupling surface 111.

The removal member coupling surface 111 may be located at a relatively lower side with respect to the central axis of the brush 200. Accordingly, trash (H) such as fur adhered to the adhesive member 210 of the brush 200 may be swept and easily separated by the removal member 300.

The removal member coupling surface 111 may extend in a direction in which the lower frame 110 extends, or in a left-right direction in the illustrated embodiment. In one embodiment, the removal member coupling surface 111 may be extended by an extension length of the lower frame 110. In other words, each end portion in a direction in which the removal member coupling surface 111 extends may overlap with an end portion in each direction in which the lower frame 110 extends in a front-rear direction.

Side frames 120 are located at respective end portions in both directions in which the lower frame 110 extends, and at left and right end portions in the illustrated embodiment, respectively.

The side frames 120 define respective end portions in a length direction of the frame 100 and in a left-right direction in the illustrated embodiment. The side frames 120 are coupled to end portions in respective directions in which the brush 200 extends, and to the left and right end portions, respectively, in the illustrated embodiment.

Either one of the side frames 120, the side frame 120 located on the right side in the illustrated embodiment, may have a through hole formed in the length direction. A power part 500 for rotating the gear part 400 may be coupled to the through hole to pass therethrough.

The brush 200 and the removal member 300 are rotatably coupled to the side frame 120. In other words, the side frame 120 is not rotated irrespective of the rotation of the brush 200 and the removal member 300.

The side frame 120 may be defined in a shape corresponding to the shape of the inner space of the nozzle housing 50. In the illustrated embodiment, the side frame 120 is provided in a plate shape in which an upper end portion thereof is defined to be rounded in a convex manner toward the upper side.

The brush 200 is rotated to collect various types of trash staying on the floor surface (G).

The brush 200 is rotatably coupled to the frame 100. Specifically, both end portions of the brush 200 are rotatably supported by a plurality of side frames 120.

The brush 200 is disposed to extend in one direction. In the illustrated embodiment, the brush 200 is formed to extend in a left-right direction. It will be understood that the extension direction is the same as that of the nozzle housing 50.

Accordingly, when the robot cleaner 1 moves forward, an area that the brush 200 sweeps may increase. Accordingly, the cleaning efficiency of the robot cleaner 1 may be improved.

The brush 200 may have any shape that is rotatable between the side frames 120. In the illustrated embodiment, the brush 200 has a circular cross section and a cylindrical shape extending in a left-right direction.

In the above embodiment, even when the rotation of the brush 200 is advanced, a distance between the center of the cross section and the outer circumference of the brush 200 may be kept constant to perform an efficient cleaning operation.

Respective end portions in a direction in which the brush 200 extends, left and right end portions in the illustrated embodiment are rotatably coupled to the side frames 120, respectively.

One side of the brush 200, a lower side in the illustrated embodiment, is partially exposed to an outside of the lower frame 110. Through the exposed portion, trash (H) such as fur located on the floor surface (G) may be adhered to the adhesive member 210 of the brush 200.

The brush 200 is supported by the lower frame 110. In addition, the brush 200 is partially supported by the removal member 300. In one embodiment, the brush 200 may be rotated while being in contact with the removal member 300.

Accordingly, trash (H) such as fur adhered to the adhesive member 210 of the brush 200 may be effectively separated by the removal member 300.

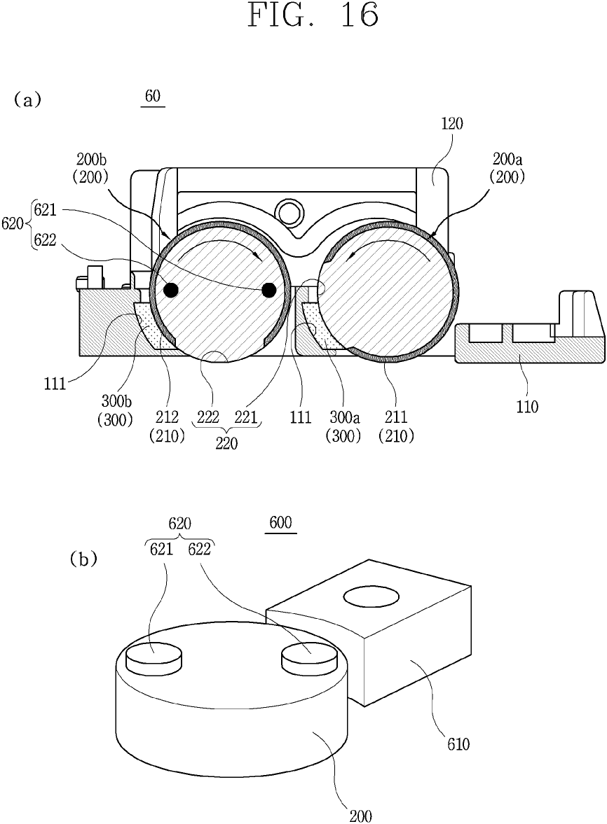

The sensor part 600 (see FIG. 16) is provided at least one of the respective end portions in a direction in which the brush 200 extends. The sensor part 600 may sense information related to rotation, such as a rotation direction and a rotation angle of the brush 200. The detailed description thereof will be described later.

A main gear 410 is coupled to an outer circumference of each end portion in a direction in which the brush 200 extends, or the left and right end portions in the illustrated embodiment. The main gears 410 are gear-coupled to sub-gears 420 located adjacent to an outer circumference of the brush 200, respectively.

Accordingly, when the power part 500 is operated, the plurality of brushes 200 may be rotated in different directions. As a result, a plurality of brushes 200 may be operated by a single power part 500.

A plurality of brushes 200 may be provided. Each of the plurality of brushes 200 may be provided at different positions of the lower frame 110, and rotatably coupled to the side frames 120.

In the illustrated embodiment, the brush 200 includes a first brush 200a locate at the rear side and a second brush 200b located at the front side.

The first brush 200a and the second brush 200b are disposed to be spaced apart from each other. In the illustrated embodiment, the first brush 200a and the second brush 200b are disposed to face each other with the removal member coupling surface 111 and the first removal member 300a located at the rear side therebetween.

The first brush 200a and the second brush 200b may be rotated independently of each other. In other words, the first brush 200a and the second brush 200b may have different rotation directions and rotation speeds.

In one embodiment, the first brush 200a and the second brush 200b may be rotated in opposite directions. The difference is achieved by the adjustment of the gear part 400 which will be described later.

Accordingly, while either one brush of the first brush 200a and the second brush 200b adheres trash (H) such as fur existing on the floor surface (G), the other one brush of the first brush 200a and the second brush 200b separates trash (H) such as fur that has been previously adhered thereto.

The first brush 200a is coupled to a first main gear 411. The second brush 200b is coupled to a second main gear 412. As will be described later, the first main gear 411 and the second main gear 412 are gear-coupled to a second sub-gear 422 and a first sub-gear 421, respectively. The detailed description thereof will be described later.

The brush 200 may be formed of a lightweight and high rigid material. In one embodiment, the brush 200 may be formed of a synthetic resin material such as reinforced plastic.

The brush 200 includes an adhesive member 210 and an exposed part 220.

The adhesive member 210 defines part of an outer circumferential surface of the brush 200. In other words, the adhesive member 210 is provided on the brush 200 to surround part of the outer circumferential surface of the brush 200.

In the illustrated embodiment, the adhesive member 210 is disposed to surround at least half of the outer circumferential surface of the brush 200. In this case, a portion of the outer circumferential surface of the brush 200 that is not covered by the adhesive member 210 may be defined as the exposed part 220. An area of the adhesive member 210 may be defined such that an area of the exposed part 220 is larger than that of the removal member 300.

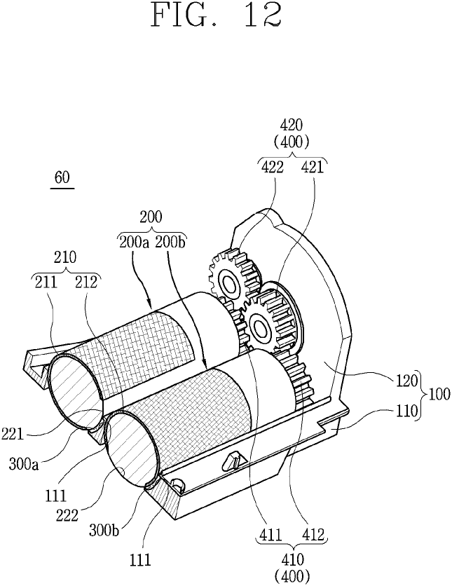

In other words, as illustrated in FIGS. 11 and 12, the adhesive member 210 is disposed to have a predetermined length along the outer circumference of the brush 200. In this case, a length in the circumferential direction of a portion of the outer circumference of the brush 200 that is not covered by the adhesive member 210 may be disposed to be larger than that in the circumferential direction of the removal member 300.

The adhesive member 210 may be formed of a material having a predetermined roughness. This is to easily collect trash (H) such as fur staying on the floor surface (G) by frictional force and electrostatic attraction.

Furthermore, the adhesive member 210 may be formed of a material having a predetermined adhesive strength. This is to facilitate collection by pressing and adhering trash (H) such as fur staying on the floor surface (G).

In one embodiment, the adhesive member 210 may be formed of a fibrous material such as felt, blended fabric, linen, or bristle. Alternatively, the adhesive member 210 may be formed of a material such as rubber, latex, or acryl.

In this case, the roughness of a surface in a direction in which the adhesive member 210 is exposed to the outside, and in a direction toward a radial outer side with respect to the center of the brush 200 in the illustrated embodiment is preferably defined to be relatively higher.

As the brush 200 and the adhesive member 210 provided therein are rotated, trash (H) such as fur located on the floor surface (G) may adhere to the adhesive member 210. Trash (H) such as sticky fur may be rotated together with the brush 200 and the adhesive member 210, and then separated by the removal member 300. The detailed description thereof will be described later.

A plurality of adhesive members 210 may be provided. The plurality of adhesive members 210 may be provided on the plurality of brushes 200, respectively. In other words, the plurality of adhesive members 210 may be disposed to surround the outer circumferences of the plurality of brushes 200, respectively.

In the illustrated embodiment, the adhesive member 210 includes a first adhesive member 211 provided on the first brush 200a and a second adhesive member 212 provided on the second brush 200b.

The first adhesive member 211 is disposed to surround an outer circumference of the first brush 200a. As the first brush 200a is rotated, the first adhesive member 211 may be in contact with or spaced apart from the first removal member 300a. When the first adhesive member 211 is in contact with the first removal member 300a, trash (H) such as fur adhered to the first adhesive member 211 may be separated.

The second adhesive member 212 is disposed to surround an outer circumference of the second brush 200b. As the second brush 200b is rotated, the second adhesive member 212 may be in contact with or spaced apart from the second removal member 300b. When the second adhesive member 212 is brought into contact with the second removal member 300b, trash (H) such as fur adhered to the second adhesive member 212 may be separated.

The exposed part 220 is defined as the remaining part of the outer circumference of the brush 200 except for part covered by the adhesive member 210. In other words, the exposed part 220 is a portion of the outer circumference of the brush 200 that is directly exposed to the outside.

Accordingly, the exposed part 220 may be defined as an arc whose center is located on the central axis of the brush 200, and having the same curvature as the outer circumference of the brush 200.

Accordingly, one end portion in a circumferential direction in which the adhesive member 210 extends and one end portion in a circumferential direction in which the exposed part 220 extends are continuous with each other. Similarly, the other end portion in the circumferential direction from which the adhesive member 210 extends and the other end portion in the circumferential direction from which the exposed part 220 extends are continuous with each other.

As will be described later, when either one of the one end portion or the other end portion of the exposed part 220 is adjacent to one end portion of the removal member 300, the power part 500 is rotated in one direction. In addition, when the other one of the one end portion and the other end portion of the exposed part 220 is adjacent to the other end portion of the removal member 300, the power part 500 is rotated in another direction.

Accordingly, the adhesive member 210 adheres to trash (H) such as fur located on the floor surface (G), and trash (H) such as fur adhered in contact with the removal member 300 may be separated. The detailed description thereof will be described later.

A plurality of exposed parts 220 may be provided. The plurality of exposed parts 220 may be arranged on the plurality of brushes 200, respectively. In the illustrated embodiment, the exposed part 220 includes a first exposed part 221 disposed on the first brush 200a and a second exposed part 222 disposed on the second brush 200b.

It will be understood that the first exposed part 221 and the second exposed part 222 are respectively defined as a portion that is not provided with the first adhesive member 211 and the second adhesive member 212 on the outer circumferential surfaces of the first and second brushes 200a, 200b.

The removal member 300 is provided adjacent to an outer circumference of the brush 200.

The removal member 300 separates trash adhered to the adhesive member 210 of the brush 200, particularly, trash (H), such as fur, from the adhesive member 210. The separated adhesive member 210 may be removed into the inside of the nozzle housing 50, and moved and collected into the dust bin 30 through the communication part 53.

The removal member 300 is located adjacent to the brush 200. Specifically, the removal member 300 is coupled to the removal member coupling surface 111 disposed on the lower frame 110. According to the location of the removal member coupling surface 111 as described above, the removal member 300 is also located at a lower side compared to the central axis of the brush 200.

In the illustrated embodiment, the removal member 300 is located at a front lower side of the brush 200 at a radial outer side of the brush 200. The removal member 300 is disposed to partially surround a outer circumference of the brush 200.

The removal member 300 may be defined in a shape corresponding to the shape of an outer circumference of the brush 200. In the illustrated embodiment, the brush 200 has a cylindrical shape having a circular cross section, and the removal member 300 may be defined in an arc-shaped cross section having a predetermined curvature.

In this case, the center of the removal member 300 may be located at the central axis of the brush 200. Furthermore, a curvature of the removal member 300 may be defined to be the same as that of the outer circumference of the brush 200.

The removal member 300 may extend in the same direction as the brush 200, in a left-right direction in the illustrated embodiment. The removal member 300 may have both end portions in an extending direction thereof, left and right end portions in the illustrated embodiment, respectively, coupled to the side frames 120.

In other words, the removal member 300 may be extended by an extension length of the lower frame 110 or the removal member coupling surface 111. In other words, each end portion in a direction in which the removal member 300 extends may overlap with each end portion in a direction in which the lower frame 110 or the removal member coupling surface 111 extends in a front-rear direction.

The removal member 300 may be formed of a material having a lower roughness than the adhesive member 210. This is to more easily separate trash (H) such as fur adhered to the adhesive member 210 by being in contact with the adhesive member 210.

In one embodiment, the removal member 300 may be formed of a cotton flannel material.

The removal member 300 may alternately be in contact with and spaced apart from each other with the first adhesive member 211 and the second adhesive member 212. In other words, at a specific point in time, the removal member 300 is in contact with either one of the first adhesive member 211 and the second adhesive member 212, and separated from the other one of the first adhesive member 211 and the second adhesive member 212.

Accordingly, while either one brush of the first brush 200a and the second brush 200b adheres trash (H) such as fur, the other one brush of the first brush 200a and the second brush 200b may separate trash (H) such as fur that has been previously adhered thereto.

A plurality of removal members 300 may be provided. The plurality of removal members 300 are located adjacent to the plurality of brushes 200, respectively. The plurality of removal members 300 are spaced apart from or in contact with the plurality of adhesive members 210, respectively.

In the illustrated embodiment, two removal members 300 including a first removal member 300a and a second removal member 300b are provided. The first removal member 300a is located adjacent to the first brush 200a to be in contact with or spaced apart from the first adhesive member 211. The second removal member 300b is located adjacent to the second brush 200b to be in contact with or spaced apart from the second adhesive member 212.

The gear part 400 transmits the rotation of the power part 500 to the brush 200. In addition, the gear part 400 is coupled to the plurality of brushes 200a, 200b, respectively, to transmit a rotational force.

Accordingly, the plurality of brushes 200a, 200b may both be rotated by a single power part 500.

Furthermore, by the gear part 400, the first brush 200a and the second brush 200b may be rotated in different directions.

The gear part 400 is connected to the power part 500. When the power part 500 is operated, the gear part 400 may be rotated.

A plurality of gear parts 400 may be provided. The plurality of gear parts 400 may be located at respective end portions in a direction in which the brush 200 extends. In the illustrated embodiment, two gear parts 400 are provided, and located at left and right end portions of the brush 200, respectively.

In the above embodiment, the gear part 400 is coupled to the left end and the right end of the brush 200, respectively. Accordingly, the brush 200 and the gear part 400 may be integrally rotated.

In the illustrated embodiment, the gear part 400 includes a main gear 410 and a sub-gear 420.

The main gear 410 is coupled to the brush 200. The main gear 410 may be rotated together with the brush 200. In the illustrated embodiment, the main gear 410 is coupled to the brush 200 at both end portions in a direction in which the brush 200 extends.

The main gear 410 is rotated together with the brush 200. The main gear 410 may be rotatably coupled to the side frame 120.

The main gear 410 is gear-fitted to the sub-gear 420. The maingear 410 may be provided in any form capable of being gear-coupled to the sub-gear 420.

A plurality of main gears 410 may be provided. The plurality of main gears 410 may be respectively coupled to the plurality of brushes 200, and rotated together with each brush 200.

In the illustrated embodiment, the main gear 410 includes a first main gear 411 coupled to the first brush 200a and a second main gear 412 coupled to the second brush 200b.

The first main gear 411 is coupled to an end portion in a direction in which the first brush 200a extends. A plurality of first main gears 411 are provided, and respectively coupled to both end portions in a direction in which the first brush 200a extends.

The first main gear 411 is gear-coupled to the second sub-gear 422. Accordingly, the first main gear 411 is rotated in a direction opposite to the second sub-gear 422.

The second main gear 412 is coupled to an end portion in a direction in which the second brush 200b extends. A plurality of second main gears 412 are provided, and respectively coupled to both end portions in a direction in which the second brush 200b extends.

The second main gear 412 is gear-coupled to the first sub-gear 421. Accordingly, the second main gear 412 is rotated in a direction opposite to the first sub-gear 421.

The main gear 410 may include a plurality of teeth parts. In other words, the main gear 410 may include a plurality of concave portions and a plurality of convex portions that are alternately arranged with each other along an outer circumference thereof.

The sub-gear 420 is coupled to the power part 500 to rotate according to the operation of the power part 500. Furthermore, the sub-gear 420 is gear-coupled to the main gear 410. Accordingly, when the power part 500 is operated, the sub-gear 420 coupled thereto and the main gear 410 connected to the sub-gear 420 are rotated. As a result, the brush 200 coupled to the main gear 410 may also be rotated.

The sub-gear 420 may be provided in any form capable of being gear-coupled to the main gear 410.

The sub-gear 420 may be rotatably coupled to the side frame 120. In addition, the sub-gear 420 is located adjacent to each end portion in a direction in which the brush 200 extends and the main gear 410 coupled thereto.

A plurality of sub-gears 420 may be provided. The plurality of sub-gears 420 may be gear-coupled to the plurality of main gears 410 at respective end portions in a direction in which the brush 200 extends.

In the illustrated embodiment, the sub-gear 420 includes a first sub-gear 421 and a second sub-gear 422. The first sub-gear 421 is located between the first main gear 411 and the second main gear 412, and coupled to the power part 500. The second sub-gear 422 is located at an upper side of the first main gear 411.

The first sub-gear 421 is gear-coupled to the second main gear 412 and the second sub-gear 422, respectively. The second sub-gear 422 is gear-coupled to the first main gear 411 and the first sub-gear 421.

Accordingly, the rotation of the power part 500 is first transmitted to the first sub-gear 421. The rotation of the first sub-gear 421 is transmitted to the second main gear 412 and the second sub-gear 422. In addition, the rotation of the second sub-gear 422 is transmitted to the first main gear 411.

The sub-gear 420 may include a plurality of teeth parts. In other words, the sub-gear 420 may include a plurality of concave portions and a plurality of convex portions alternately arranged with each other along an outer circumference thereof.

The power part 500 generates power for rotating the brush 200. The power part 500 is coupled to the sub-gear 420 of the gear part 400, in particular, the first sub-gear 421. The power part 500 and the first sub-gear 421 may be rotated together.

The power part 500 may be provided in any form capable of controlling rotation or non-rotation, rotation direction, rotation speed or the like thereof by an input of an electrical signal. In one embodiment, the power part 500 may be provided with an electric motor.

The power part 500 is connected to the controller 700 to be electrically conductive. The connection may be carried out in a wireless or wired manner.

The power part 500 is electrically connected to an external power source (not shown) and a controller (not shown). Power for operating the power part 500 may be supplied from the power source (not shown). In addition, a control signal for controlling the rotation or non-rotation, rotation direction, rotation speed or the like of the power part 500 may be applied from the controller (not shown).

The power part 500 may be coupled to the side frame 120 of the frame 100. Accordingly, the power part 500 may be stably supported.

The detailed description of a process of rotating the brush 200 as the power part 500 is operated will be described later.

The sensor part 600 senses the rotation direction and rotation angle of the brush 200. Information on the rotation sensed by the sensor part 600 is transmitted to the controller 700. The controller 700 calculates the rotation information of the brush 200 and operation information for operating the power part 500 accordingly using the information.

The sensor part 600 is connected to the controller 700 to be electrically conducted. The information sensed by the sensor part 600 may be transmitted to the controller 700. The electrical conduction between the sensor part 600 and the controller 700 may be carried out in a wired manner through a conductor member (not shown) or in a wireless manner such as Bluetooth.

The sensor part 600 is located adjacent to the brush 200. The sensor part 600 senses the rotation direction and rotation speed of the brush 200. The sensor part 600 may be provided in any form capable of sensing the rotation or non-rotation, rotation direction, rotation speed or the like of another member.

The sensor part 600 is located adjacent to one end portion of the brush 200 to sense the rotation of the brush 200. In the illustrated embodiment, the sensor part 600 is provided in the form of a hall sensor. In addition, in the illustrated embodiment, the sensor part 600 is located adjacent to one end portion of the second brush 200b.

Alternatively, the sensor part 600 may be provided with an encoder sensor, a photo sensor or the like. Furthermore, alternatively, the sensor part 600 may be provided at one end portion of the first brush 200a.

In other words, the sensor part 600 may be provided at one or both end portions of at least one of the first and second brushes 200a, 200b.

In the illustrated embodiment, the sensor part 600 includes a sensing unit 610 and a magnetic body 620.

The sensing unit 610 is located adjacent to the end portion of the brush 200. The sensing unit 610 senses a magnetic field formed by the magnetic body 620 rotated together with the brush 200.

The sensing unit 610 may not be rotated irrespective of the brush 200. This is to more accurately sense a magnetic field formed by the brush 200 and the magnetic body 620 coupled thereto.

In one embodiment, the sensing unit 610 may be coupled to the lower frame 110 or the side frame 120.

Information sensed by the sensing unit 610, that is, information on the rotation of the brush 200 is transmitted to the controller 700.

The magnetic body 620 is located adjacent to the sensing unit 610.

The magnetic body 620 is rotated together with the brush 200. Accordingly, when the brush 200 is rotated, the location of the magnetic body 620 and the strength and direction of a magnetic field formed by the magnetic body 620 are changed. The sensing unit 610 senses the change to transmit it to the sensor part 600.

The magnetic body 620 may be coupled to the brush 200. In the illustrated embodiment, the magnetic body 620 is coupled to one end portion of the second brush 200b to rotate together with the second brush 200b.

In other words, in the illustrated embodiment, the sensor part 600 may sense the rotation of the second brush 200b.

The magnetic body 620 may be provided in any form capable of forming a magnetic field. In one embodiment, the magnetic body 620 may be provided in the form of a permanent magnet or an electromagnet.

A plurality of magnetic bodies 620 may be provided. The plurality of magnetic bodies 620 may be disposed at a plurality of positions in the cross section of the brush 200. In this case, the plurality of magnetic bodies 620 may be disposed to be spaced apart from each other along an outer circumference of the cross section of the brush 200. Accordingly, the sensing unit 610 may accurately sense a magnetic field formed as the brush 200 is rotated.

In the illustrated embodiment, two magnetic bodies 620 including a first magnetic body 621 and a second magnetic body 622 are provided. The first magnetic body 621 and the second magnetic body 622 are disposed to face each other with the center of the brush 200 interposed therebetween.

In one embodiment, the first magnetic body 621 and the second magnetic body 622 may be located adjacent to an outer circumference of the cross section of the brush 200. In the above embodiment, as the brush 200 is rotated, a distance at which the first magnetic body 621 and the second magnetic body 622 move increases to also enhance the strength of the formed magnetic field.

A process of sensing a magnetic field formed by the rotation of the magnetic body 620 by the sensing unit 610 is a well-known technology, and thus the detailed description thereof will be omitted.

Although not shown, the magnetic body 620 may be located inside the brush 200. The magnetic body 620 may be located inside at a specific position in a direction in which the brush 200 extends, that is, in a left-right direction in the illustrated embodiment.

In the above embodiment, the sensing unit 610 may be disposed to overlap with the magnetic body 620 in a top-down direction or a front-rear direction. Even in this case, the sensing unit 610 is preferably spaced apart from the brush 200 not to rotate together with the brush 200.

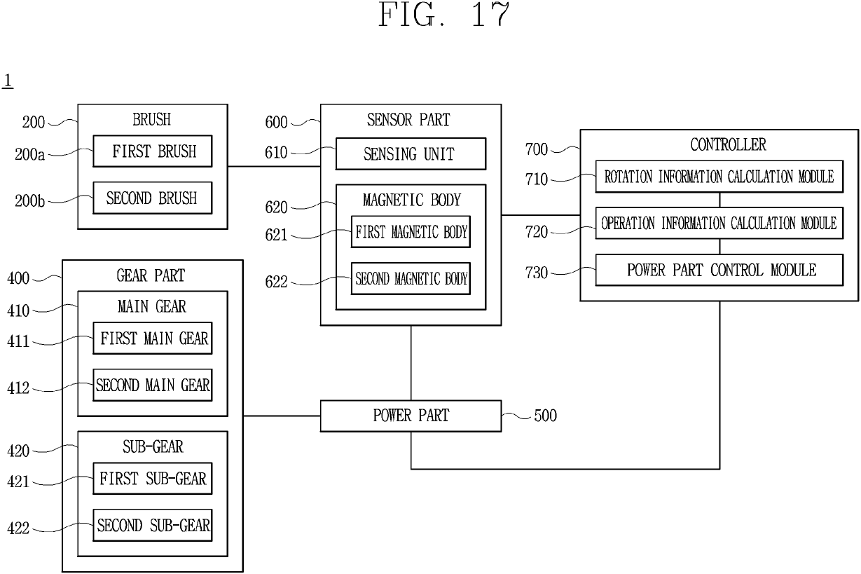

Referring to FIG. 17, the nozzle part 60 according to an embodiment of the present invention further includes a controller 700.

The controller 700 calculates information related to the rotation of the brush 200 using information sensed by the sensor part 600. In addition, the controller 700 calculates information related to the operation of the power part 500 using the calculated information. Furthermore, the controller 700 controls the power part 500 according to the calculated information.

The controller 700 is connected to the sensor part 600 to be electrically conducted. Information sensed by the sensor part 600 may be transmitted to the controller 700.

The controller 700 is connected to the power part 500 to be electrically conducted. The controller 700 may control the rotation or non-rotation, rotation direction, rotation speed or the like of the power part 500 based on the calculated information.

The electrically conductive connection may be formed by wired or wireless means. In one embodiment, the controller 700 may be provided in any form capable of allowing the input, output, and calculation of information.

In one embodiment, the controller 700 may be provided with a microprocessor, a CPU, or the like.

In one embodiment, the controller 700 may be accommodated in an inner space of the body portion 10. In the above embodiment, when the nozzle housing 50 accommodating the nozzle part 60 is coupled to the body part 10, the controller 700 may be connected to the power part 500 and the sensor part 600 to be electrically conductive.

In another embodiment, the controller 700 may be accommodated in an inner space of the nozzle housing 50. In the above embodiment, as the nozzle housing 50 is coupled to the body part 10, power for operating the controller 700 may be transmitted to the controller 700 from a power source accommodated inside the body portion 10.

The controller 700 includes a plurality of modules 710, 720, 730. The plurality of modules 710, 720, 730 may be connected to each other so as to be electrically conductive to each other. Each of the information received or calculated by each module 710, 720, 730 may be transmitted to another module 710, 720, 730.

In the illustrated embodiment, the controller 700 includes a rotation information calculation module 710, an operation information calculation module 720, and a power part control module 730.

The rotation information calculation module 710 calculates rotation information, which is information on the rotation state of the brush 200, using information sensed by the sensor part 600. The rotation information calculation module 710 is connected to the sensor part 600 in a wired or wireless manner so as to be electrically conductive.

As described above, the sensor part 600 senses information on the current rotation state of the brush 200. The information may be defined as “information on the rotation of the brush 200”.

At this time, the information on the rotation of the brush 200 is expressed as information related to a change in the intensity and direction of a magnetic field sensed by the sensor part 600.

Accordingly, the rotation information calculation module 710 calculates rotation information using information on the rotation of the brush 200. The rotation information includes information related to the rotation or non-rotation, rotation direction, rotation speed or the like of the brush 200.

In one embodiment, the calculated rotation information may include information on whether one end portion of the adhesive member 210 is in contact with one end portion or the other end portion of the removal member 300.

The calculated rotation information is transmitted to the operation information calculation module 720. The rotation information calculation module 710 and the operation information calculation module 720 are connected to be electrically conductive.

The operation information calculation module 720 calculates information for operating the power part 500 using the calculated rotation information. The information may be defined as “operation information”.

The operation information calculated by the operation information calculation module 720 may include information related to the rotation or non-rotation, rotation direction, rotation speed or the like of the power part 500.

In addition, the operation information calculation module 720 may calculate operation information according to whether respective end portions of the adhesive member 210 and the removal member 300 are spaced apart or in contact with each other, among rotation information calculated by the rotation information calculation module 710.

For example, while the second brush 200b provided with the sensor part 600 is rotated in one direction, the calculated rotation information indicates that one end portion of the adhesive member 210 is in contact with one end portion or the other end portion of the removal member 300, the operation information calculation module 720 calculates operation information for rotating the second brush 200b in an opposite direction.

At this time, as described above, the first brush 200a and the second brush 200b are rotated in opposite directions. Accordingly, it will be understood that the operation information includes the content of rotating the first brush 200a in a direction in which the second brush 200b was previously rotated.

Accordingly, the first brush 200a may be repeatedly rotated in one direction and another direction. Likewise, the second brush 200b may be repeatedly rotated in the another direction and the one direction. The detailed description of the process will be described later.

The operation information calculated by the operation information calculation module 720 is transmitted to the power part control module 730. The operation information calculation module 720 and the power part control module 730 are connected to be electrically conductive.

The power part control module 730 controls the power part 500 according to the calculated operation information. As described above, the calculated operation information includes information related to the rotation or non-rotation, rotation direction, rotation speed or the like of the power part 500.

Accordingly, the power part control module 730 controls the rotation or non-rotation, rotation direction, rotation speed or the like of the power part 500 according to the calculated operation information. The power part control module 730 is connected to the power part 500 to be electrically conductive.

When the power part 500 is operated by the power part control module 730, the brush 200 is also rotated. The rotation of the brush 200 is sensed by the sensor part 600 and transmitted to the controller 700 again to repeat the above process.

Accordingly, while the robot cleaner 1 is operating, the power part 500 may be controlled in real time to change the rotation direction of the brush 200 in real time.

### Description of Operation Process of Nozzle Part 60

In the nozzle part 60 according to an embodiment of the present disclosure, the brush 200 may be rotated by a single number of the power part 500 through the foregoing configuration.

Furthermore, while either one brush 200 of the first brush 200a and the second brush 200b collects trash (H) such as fur, the other one brush 200 of the first brush 200a and the second brush 200b may separate trash (H) such as fur.

In other words, the first brush 200a and the second brush 200b constituting the brush 200 are rotated in different directions. Accordingly, compared to a case where both the first and second brushes 200a, 200b perform an adhesive operation at a time, and perform a separation operation, an effect on the driving of the robot cleaner 1 may be reduced.

For example, it may be assumed that the brush 200 is rotated in a clockwise direction to perform an adhesion operation, and rotated in a counterclockwise direction to perform a separation operation.

In addition, when the brush 200 is rotated in a clockwise direction, it may be assumed that the driving of the robot cleaner 1 is accelerated. Likewise, when the brush 200 is rotated in a counterclockwise direction, it may be assumed that the driving of the robot cleaner 1 is decelerated.

At this time, by the foregoing configuration, either one of the first brush 200a and the second brush 200b is always rotated in a clockwise direction. Accordingly, a driving resistance of the robot cleaner 1 generated by the rotation of the brush 200 may be minimized.

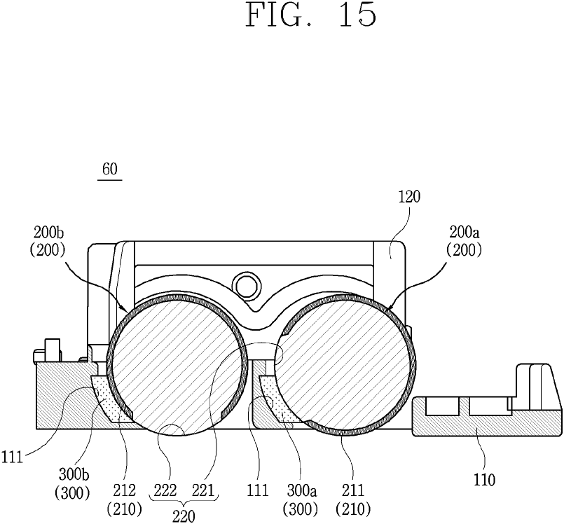

Hereinafter, an operation process of the nozzle part 60 according to an embodiment of the present disclosure will be described in detail with reference to FIGS. 15 and 16.

The power part 500 is electrically connected to a power source (not shown) and a controller 700 by a member such as an electric wire. When power and control signals are applied to the power part 500, the power part 500 is rotated.

Accordingly, the first sub-gear 421 coupled to the power part 500 is rotated in the same direction as the power part 500.

The first sub-gear 421 is gear-coupled to the second main gear 412 and the second sub-gear 422. Accordingly, the second main gear 412 and the second sub-gear 422 are rotated in a direction opposite to the first sub-gear 421.

The second main gear 412 is coupled to the second brush 200b. Accordingly, the second brush 200b is also rotated in a direction opposite to the power part 500 and the first sub-gear 421.

On the other hand, the second sub-gear 422 is gear-coupled to the first main gear 411. Accordingly, the first main gear 411 is rotated in the same direction as the power part 500 and the first sub-gear 421.

In addition, the first main gear 411 is coupled to the first brush 200a. Accordingly, the first brush 200a is rotated in the same direction as the power part 500 and the first sub-gear 421.

Accordingly, the first brush 200a and the second brush 200b may be rotated in different directions.

First, it will be described under the assumption that the first brush 200a is rotated in a clockwise direction and the second brush 200b is rotated in a counterclockwise direction.

When the second brush 200b is rotated in a clockwise direction, the sensor part 600 senses the strength and direction of a magnetic field formed by the magnetic body 620 rotated together with the second brush 200b.

The sensed result is transmitted to the rotation information calculation module 710 of the controller 700.

The rotation information calculation module 710 calculates rotation information using the transmitted information. In particular, after one end portion of the second adhesive member 212 is located at one end portion of the second removal member 300b, the rotation information calculation module 710 calculates whether the other end portion of the second adhesive member 212 is rotated up to the other end portion of the second removal member 300b.

In other words, in an embodiment illustrated in FIG. 16, after a front end portion of the second adhesive member 212 is in contact with an upper end portion of the second removal member 300b, the rotation information calculation module 710 calculates whether the second brush 300b is rotated in a clockwise direction such that a rear end portion of the second adhesive member 212 is in contact with a lower end portion of the second removal member 300b.

In the above process, trash (H) such as fur is adhered to the second adhesive member 212. Furthermore, on the first brush 200a rotated in a direction opposite to the second brush 200b, trash (H) such as fur adhered to the first adhesive member 211 is separated while in contact with the removal member 300.

The operation information calculation module 720 calculates operation information by using the calculated rotation information.

In particular, in case where the calculated rotation information indicates that one end portion of the second adhesive member 212 is located at one end portion of the second removal member 300b, and then the other end portion of the second adhesive member 212 is rotated up to the other end portion of the second removal member 300b, the operation information operation module 720 calculates operation information having the content of rotating the power part 500 in an opposite direction.

The power part control module 730 controls the power part 500 according to the calculated operation information. In the foregoing embodiment, the power part 500 is rotated in a direction opposite to the initial state.

In other words, in the above embodiment, the second brush 200b is rotated in a counterclockwise direction. Accordingly, on the second brush 200b, an operation of separating trash (H) such as fur adhered to the second adhesive member 212 is carried out. In addition, on the first brush 200a, an operation of adhering trash (H) such as fur to the first adhesive member 211 is carried out.

Accordingly, in the nozzle part 60 according to an embodiment of the present disclosure, a plurality of brushes 200 are repeatedly rotated in different directions. Accordingly, on each of the brushes 200a, 200b, adhesion and separation of trash (H) such as fur are repeated.

As a result, trash (H) such as fur may be easily collected, separated, and collected in the dust bin 30.

Furthermore, a size of driving resistance applied to the robot cleaner 1 by the rotation of each of the brushes 200a, 200b may be minimized.

### 4. Description of Control Method of Nozzle Part 60 According to Embodiment of the Present Disclosure and Robot Cleaner 1 Including the Same

Hereinafter a control method of the nozzle part 60 according to an embodiment of the present disclosure and a robot cleaner 1 including the same will be described in detail with reference to FIGS. 17 through 23.

A configuration for implementing the control method of the robot cleaner 1 has been described in the preceding paragraph, and the redundant description thereof will be omitted.

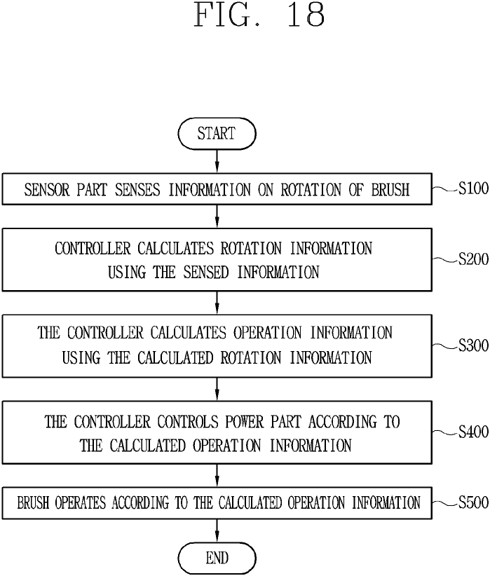

Referring to FIG. 18, the control method of the robot cleaner 1 according to an embodiment of the present disclosure includes allowing the sensor part 600 to sense information on the rotation of the brush 200 (S100), allowing the controller 700 to calculate rotation information using the sensed information (S200), allowing the controller 700 to calculate operation information using the calculated rotation information (S300), allowing the controller 700 to control the power part 500 according to the calculated operation information (S400), and allowing the brush 200 to be operated according to the calculated operation information (S500).

### Description of Step S100 of Allowing Sensor Part 600 to Sense Information on Rotation of Brush 200

The step S100 is a step of allowing the sensor part 600 to sense information related to the rotation of the brush 200 rotated by the power part 500, and transmit the sensed information to the controller 700.

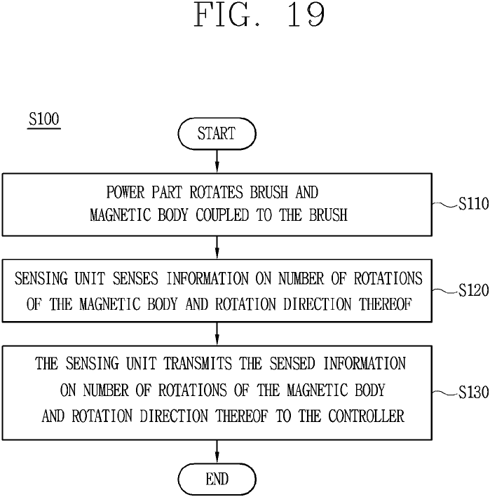

Hereinafter, this step will be described in detail with reference to FIG. 19.

First, the power part 500 is operated to rotate the brush 200 and the magnetic body 620 coupled to the brush 200 (S110). At this time, the first brush 200a and the second brush 200b are rotated in different directions.

The sensing unit 610 of the sensor part 600 senses information on the number of rotations of the magnetic body 620 and information on the direction of rotation (S120). Specifically, the sensing unit 610 senses information on the strength and direction of a magnetic field formed by the magnetic body 620.

Information on the number of rotations of the magnetic body 620 sensed by the sensing unit 610 and information on the rotation direction are transmitted to the controller 700 (S130). To this end, the sensor part 600 and the controller 700 are connected to each other in a wired or wireless manner.

### Description of Step S200 of Allowing Controller 700 to Calculate Rotation Information Using Sensed Information

The step 200 is a step of allowing the rotation information calculation module 710 to calculate the rotation information of the brush 200 using the sensed information.

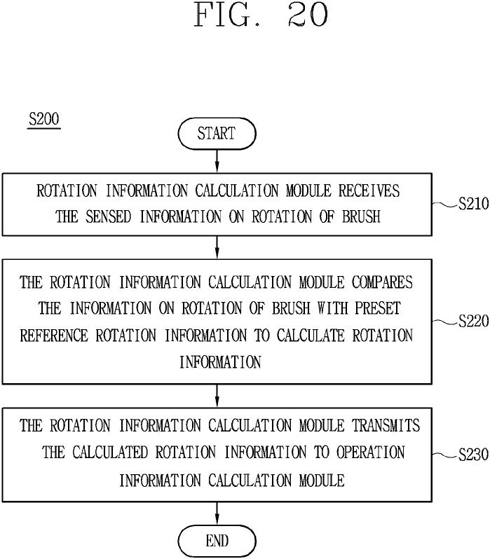

Hereinafter, this step will be described in detail with reference to FIG. 20.

The rotation information calculation module 710 receives information on the rotation of the brush 200 sensed by the sensor part 600 (S210). At this time, as described above, the information on the rotation of the brush 200 sensed by the sensor part 600 is in the form of information on a change in the intensity and direction of the magnetic field.

The rotation information calculation module 710 calculates rotation information using the received information on the rotation of the brush 200 (S220). In one embodiment, the rotation information calculation module 710 may calculate rotation information by comparing preset reference rotation information with the received information on the rotation of the brush 200.

In this case, the reference rotation information may be defined as rotation information for controlling the power part 500 to rotate in an opposite direction. In other words, the reference rotation information may be defined as rotation information indicating that one end portion of the second adhesive member 212 is located at one end portion of the second removal member 300b, and then the other end portion of the second adhesive member 212 is rotated up to the other end portion of the second removal member 300b.

Accordingly, the calculated rotation information is calculated as either one of content for maintaining the rotation direction of the power part 500 and content for changing the rotation direction of the power part 500.

The rotation information calculation module 710 transmits the calculated rotation information to the operation information calculation module 720 (S230). The rotation information calculation module 710 and the operation information calculation module 720 are connected to be electrically conductive in a wired or wireless manner.

### Description of Step S300 of Allowing Controller 700 to Calculate Operation Information Using Calculated Rotation Information

The step S300 is a step of allowing the operation information calculation module 720 to calculate operation information for controlling the power part 500 using the calculated rotation information (S300).

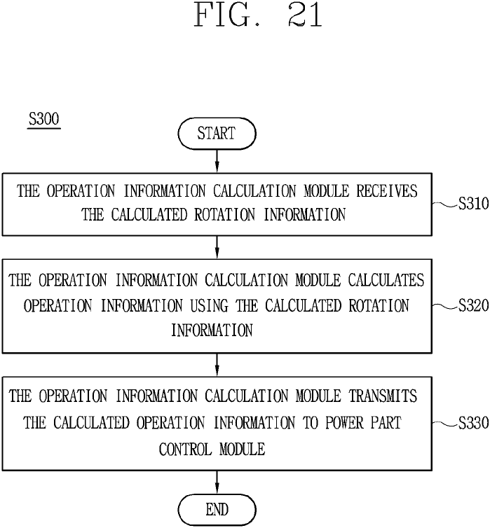

Hereinafter, this step will be described in detail with reference to FIG. 21.

The operation information calculation module 720 receives rotation information calculated by the rotation information calculation module 710 (S310). At this time, the received rotation information is either one of content for maintaining the rotation direction of the power part 500 and content for changing the rotation direction of the power part 500.

The operation information calculation module 720 calculates operation information for operating the power part 500 using the calculated rotation information (S320).

The operation information calculated by the operation information calculation module 720 is either one of content for controlling the rotation direction of the power part 500 to be maintained and content for controlling the rotation direction of the power part 500 to be changed.

The operation information calculation module 720 transmits the calculated operation information to the power part control module 730 (S330). The operation information calculation module 720 and the power part control module 730 are connected to be electrically conductive in a wired or wireless manner.

### Description of Step S400 of Allowing Controller 700 to Control Power Part 500 According to Calculated Operation Information

The step S400 is a step of allowing the power part control module 730 to control the rotation of the power part 500 according to the calculated operation information.

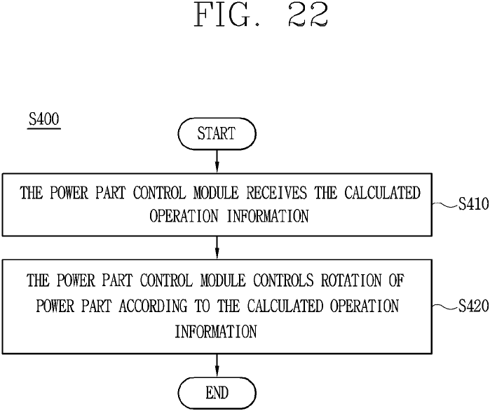

Hereinafter, this step will be described in detail with reference to FIG. 22.

The power part control module 730 receives operation information calculated by the operation information calculation module 720 (S410). At this time, the received operation information is information related to the rotation direction of the power part 500.

The power part control module 730 controls the rotation of the power part 500 according to the transmitted operation information (S420). At this time, the power part control module 730 controls the power part 500 to maintain the rotation direction of the power part 500 or change the rotation direction of the power part 500.

### Description of Step S500 of Operating the Brush 200 According To Calculated Operation Information

The step S500 is a step of operating the brush 200 connected to the power part 500 through the power part 500 and the gear part 400 according to the calculated operation information.

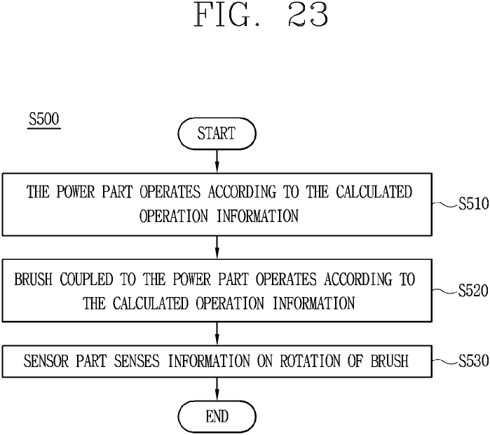

Hereinafter, this step will be described in detail with reference to FIG. 23.

By the power part control module 730, the power part 500 is operated according to the calculated operation information (S510). In other words, the power part 500 is operated to maintain the original rotation direction or rotate in a direction opposite to the original rotation direction.

The brush 200 connected to the power part 500 through the gear part 400 is operated according to the calculated operation information (S520). In an embodiment of the present disclosure, the second brush 200b directly connected to the power part 500 is rotated in an opposite direction to that of the power part 500, and the first brush 200a indirectly connected to the power part 500 is rotated in the same direction as that of the power part 500.

The sensor part 600 senses information on the rotation of the brush 200 again (S530). In other words, while the brush 200 is rotating, the sensor part 600 continuously senses information related to the rotation of the brush 200 in real time.

Accordingly, in a control method of the robot cleaner 1 according to an embodiment of the present disclosure, the rotational state of power part 500 and the brush 200 is continuously sensed in real time. In addition, the controller 700 continuously controls the power part 500 in real time according to the sensed information.

Therefore, even when the user does not perform an additional operation, the collection and separation of trash (H) such as fur may be performed in real time, continuously and efficiently. As a result, user’s convenience may be improved.

### 5. Description of Process of Collecting and Separating Trash (H) Such as Fur by Nozzle Part 60 According to Embodiment of Present Disclosure and Robot Cleaner 1 Including the Same

The nozzle part 60 according to an embodiment of the present disclosure and the robot cleaner 1 including same may effectively collect trash (H) such as fur staying in the driving environment.

In addition, the collected trash (H) such as fur may be easily separated and accommodated in the dust bin 30, even when the user does not perform an additional operation.

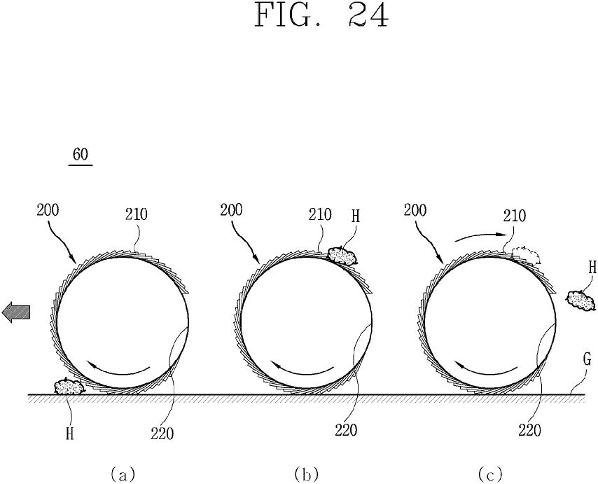

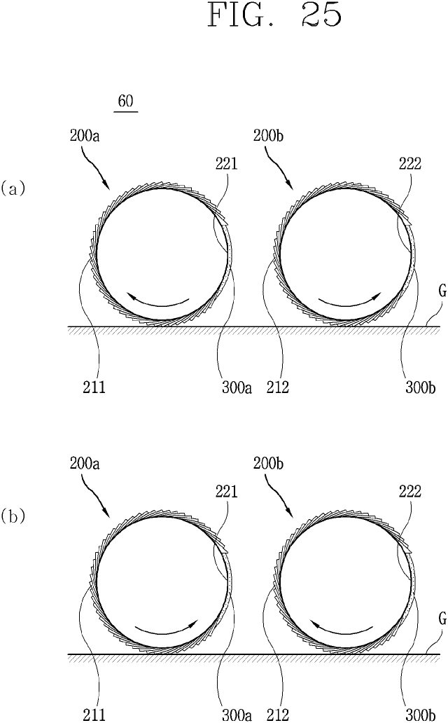

Hereinafter, with reference to FIGS. 24 and 25, a process in which trash (H) such as fur is collected and separated by the nozzle part 60 according to an embodiment of the present disclosure and the robot cleaner 1 including the same will be described in detail.

First, a process of collecting trash (H) such as fur will be described with reference to FIG. 24.

Referring to (a) of FIG. 24, the brush 200 of the nozzle part 60 provided in the robot cleaner 1 driven on the floor surface (G) toward the left side is illustrated.

Here, trash (H) such as fur is located on the floor surface (G) before the robot cleaner (1) passes therethrough.

Referring to (b) of FIG. 24, it is illustrated a state in which the robot cleaner 1 is driven and trash (H) such as fur existing on the floor surface (G) is collected by the brush 200.

As described above, the brush 200 includes an adhesive member 210 surrounding an outer circumference thereof. The adhesive member 210 may be formed of a fiber material having a high roughness such as felt.

As the rotation of the brush 200 continues, trash (H) such as fur adhered to the adhesive member 210 is rotated in a clockwise direction inside the frame 100, that is, in the illustrated embodiment.

Referring to (c) of FIG. 24, it is illustrated a state in which trash (H) such as fur adhered to the adhesive member 210 is removed.

In the above embodiment, trash (H) such as fur is removed toward a rear side of the brush 200, that is, an inner space of the nozzle housing 50.

As described above, the inner space of the nozzle housing 50 communicates with an inner space of the body part 10 and the dust bin 30 through the communication part 53.

Accordingly, the removed trash (H) such as fur is collected in the dust bin 30 through the communication part 53 and the inner space of the body part 10.

Next, with reference to FIG. 25, a process of separating the trash (H) such as fur from the brush 200 will be described.

Referring to (a) of FIG. 25, the first brush 200a located on the left side is rotated in a clockwise direction, and the second brush 200b located on the right side is rotated in a counterclockwise direction. Accordingly, trash (H) such as fur is collected from the first brush 200a, and trash (H) such as fur adhered thereto is separated from the second brush 200b (see FIG. 24).

At this time, one end portion of the first adhesive member 211 of the first brush 200a is in contact with one end portion of the first removal member 300a, and then the above state is maintained until the other end portion of the first adhesive member 211 is in contact with the other end portion of the first removal member 300b.

The time will be understood to be the same that for which one end portion of the second adhesive member 212 is in contact with one end portion of the second removal member 300b, and then the other end portion of the second adhesive member 212 is rotated up to the other end portion of the second removal member 300b.

Referring to (b) of FIG. 25, the first brush 200a located on the left side is rotated in a counterclockwise direction, and the second brush 200b located on the right side is rotated in a clockwise direction. Accordingly, trash (H) such as fur is separated from the first brush 200a, and trash (H) such as fur is collected from the second brush 200b.

In other words, it will be understood that the state is to allow operation information calculated by the controller 700 to change the rotation direction of the power part 500.

By the above process, on the first brush 200a and the second brush 200b, the adhesion and separation of trash (H) such as fur thereto are alternately performed, respectively. Furthermore, the first brush 200a and the second brush 200b are rotated in opposite directions to each other, thereby minimizing adverse effects on the driving of the robot cleaner 1.

As a result, the nozzle part 60 according to an embodiment of the present disclosure and the robot cleaner 1 including the same may effectively collect trash (H) such as fur that is difficult to remove from the floor surface (G). In addition, the collected trash (H) such as fur may be easily separated from the brush 200 and accommodated in the dust bin 30.

As a result, user’s convenience may be improved.

Though the present invention is described with reference to preferred embodiments, various modifications and improvements will become apparent to those skilled in the art without departing from the concept and scope of the present invention as defined in the following claims.

| | |
|---|---|
| 1: | Robot cleaner |
| 10: | Body part |
| 20: | Driving part |
| 30: | Dust bin |
| 40: | Sensor part |
| 50: | Nozzle housing |
| 51: | Outer housing |
| 52: | Inner housing |
| 53: | Communication part |
| 60: | Nozzle part |
| 100: | Frame |
| 110: | Lower frame |
| 111: | Removal member coupling surface |
| 120: | Side frame |
| 200: | Brush |
| 200a: | First brush |
| 200b: | Second brush |
| 210: | Adhesive member |
| 211: | First adhesive member |
| 212: | Second adhesive member |
| 220: | Exposed part |
| 221: | First exposed part |
| 222: | Second exposed part |
| 300: | Removal member |
| 300a: | First removal member |
| 300b: | Second removal member |
| 400: | Gear part |
| 410: | Main gear |
| 411: | First main gear |
| 412: | Second main gear |
| 420: | Sub-gear |
| 421: | First sub-gear |
| 422: | Second sub-gear |
| 500: | Power part |
| 600: | Sensor part |
| 610: | Sensing unit |
| 620: | Magnetic body |
| 621: | First magnetic body |
| 622: | Second magnetic body |
| 700: | Controller |
| 710: | Rotation information calculation module |
| 720: | Operation information calculation module |
| 730: | Power part control module |
| H: | Trash such as fur |
| G: | Floor surface |

1. A nozzle assembly, comprising:
a frame;
a first roller rotatably coupled to the frame to extend in an extension direction;
a second roller rotatably coupled to the frame to extend parallel to the first roller in the extension direction; and
a removal wall coupled to the frame, and located adjacent to at least one of the first roller or the second roller, wherein:
the removal wall extends along the extension direction of the first roller and the second roller,
the removal wall contacts the at least one of the first roller or the second roller, and
the first roller and the second roller rotate in different directions to each other.

2. The nozzle assembly of claim 1, wherein the first roller and the second roller have a circular cross section having a predetermined curvature, and
a cross section of an exterior surface of the removal wall facing the at least one of the first roller or the second roller has a round shape that is convex in a direction away from the at least one of the first roller or the second roller.

3. The nozzle assembly of claim 2, wherein the cross section of the exterior surface of the removal wall is defined to have a center located on a_central axis of the at least one of the first roller or the second roller, and to have a curvature that matches that of the at least one of the first roller and the second roller.

4. The nozzle assembly of claim 2, wherein the removal wall comprises:
a first removal wall located between the first roller and the second roller and adjacent to the first roller to be in contact with the first roller; and
a second removal wall located adjacent to the second roller to be in contact with the second roller.

5. The nozzle assembly of claim 1, wherein
the first roller and the second roller respectively have a cylindrical shape extending in the extension direction, and
the first roller comprises:
a first adhesive wall constituting a first region of an outer circumference of the first roller, the first adhesive wall being formed of a material having a first predetermined roughness; and
a first exposed portion constituting a second, remaining region of the outer circumference of the first roller, and
the second brush roller comprises:
a second adhesive wall constituting a first region of an outer circumference of the second roller, the second adhesive wall being formed of a material having a second predetermined roughness; and
a second exposed portion constituting a second, remaining region of the outer circumference of the second roller.

6. The nozzle assembly of claim 5, wherein the removal wall is formed of a material having a third roughness that is relatively smoother than those of the first adhesive wall and the second adhesive wall.

7. The nozzle assembly of claim 1, comprising:
a sensor assembly located adjacent to one or more of the first roller or the second roller to sense information related to a rotation of the one or more of the first roller or the second roller,
wherein the sensor assembly includes:
a magnetic body coupled to the one or more of the first roller or the second roller to rotate together with the one or more of the first roller or the second roller; and
a sensor coupled to the frame and adjacent to the magnetic body to sense a strength and a direction of a magnetic field generated by a rotation of the magnetic body on the one or more of the first roller or the second roller.

8. The nozzle assembly of claim 7, comprising:
a controller connected to the sensor assembly to receive the sensed information,
wherein the controller is configured to:
calculate rotation information on the rotation of the one or more of the first roller of the second roller based on the received sensed information;
calculate operation information on operation of a motor to drive the first and second rollers using the calculated rotation information; and
control the operation of the motor using the calculated operation information.

9. The nozzle assembly of claim 1, comprising:
a first main gear coupled to the first roller to rotate together with the first roller;
a second main gear coupled to the second roller to rotate together with the second roller;
a first sub-gear rotatably coupled to the frame, configured to be rotated by a motor, and gear-fitted to one the first main gear or the second main gear; and
a second sub-gear rotatably coupled to the frame, and gear-coupled to another one of the first main gear or the second main gear, and the first sub-gear, respectively.

10. A robot cleaner, comprising:
a body;
a dust bin detachably coupled to the body and having a space therein;
a nozzle housing detachably coupled to the body, an inner space of the nozzle housing communicating with the space of the dust bin; and
a nozzle assembly accommodated in the nozzle housing, and exposed to a cleaning surface through an opening of the nozzle housing,
wherein the nozzle assembly comprises:
a frame coupled to the nozzle housing;
a first roller rotatably coupled to the frame to extend in an extension direction;
a second roller located adjacent to the first brush rotatably coupled to the frame to extend in the extension direction; and
at least one removal wall coupled to the frame, and extending along the extension direction of the first brush and the second brush,
wherein the at least one removal wall comprises:
a first removal wall located between the first roller and the second roller and in contact with the first roller; and
a second removal wall in contact with the second roller, and
wherein the first roller and the second roller are rotated in different directions to each other.

11. The robot cleaner of claim 10, wherein each of the first roller and the second roller has a circular cross section having a predetermined curvature, and
a cross section of an exterior surface of the first removal wall has a round shape to be convex in a direction opposite to the first roller and has a curvature that matches that of the circular cross section of the first roller,
a cross section of an exterior surface of the second removal wall has a round shape to be convex in a direction opposite to the second roller and has a curvature that matches that of the circular cross section of the second roller, and
the first removal wall and the second removal wall partially surround outer circumferences of the first roller and the second roller, respectively.

12. The robot cleaner of claim 10, wherein the first roller and the second roller comprise a first adhesive wall and a second adhesive wall formed of a material having a predetermined roughness, respectively, and
the removal wall is formed of a material having a roughness that is less than that of the material of the first adhesive wall and the second adhesive wall.

13. The robot cleaner of claim 10, comprising:
a magnetic body coupled to at least one of the first roller or the second roller to rotate together with the at least one of the first roller or the second roller;
a sensor coupled to the frame and adjacent to the magnetic body to sense information on a strength and a direction of a magnetic field generated by a rotation of the magnetic body; and
a controller connected to the sensor to receive the sensed information, calculate operation information on operation of a motor the first and second rollers using the received information, and control the operation of the motor according to the calculated operation information.

14. The robot cleaner of claim 10, comprising:
a first main gear coupled to the first roller to rotate together with the first roller;
a second main gear coupled to the second roller to rotate together with the second roller;
a first sub-gear rotatably coupled to the frame, rotated by a motor, and gear-fitted to one of the first main gear or the second main gear; and
a second sub-gear rotatably coupled to the frame, and gear-fitted to another one of the first main gear or the second main gear, and the first sub-gear, respectively.

15. A method of controlling a robot cleaner, the method comprising:
sensing, by a sensor, information on a rotation of a roller included in the robot cleaner;
calculating, by a controller, rotation information of the roller using the sensed information;
calculating, by the controller, operation information using the calculated rotation information; and
controlling, by the controller, a motor to rotate the roller according to the calculated operation information.

16. The method of claim 15, wherein sensing the information on the rotation of the roller comprises:
allowing the motor to rotate the roller and a magnetic body coupled to the roller; and
sensing information on a number of rotations of the magnetic body and information on a rotation direction thereof, and
wherein the information on the rotation of the roller comprises the information on the number of rotations of the magnetic body and the information on the rotation direction of the magnetic body.

17. The method of claim 15, wherein calculating the rotation information using the sensed information comprises:
comparing the information on the rotation of the roller with preset reference rotation information to calculate the rotation information.

18-19. (canceled)

20. The method of claim 15, wherein controlling the motor to rotate the roller according to the calculated operation information comprises:
operating the motor according to the calculated operation information;
operating the roller coupled to the motor according to the operating of the motor; and
sensing information on the rotation of the roller.

21. The method of claim 15,
wherein the roller includes a first roller and a second roller that extend in parallel directions and rotate in opposite directions, and
wherein the magnetic body is coupled to one of the first roller or the second roller, and sensing the rotation of the roller includes sensing a rotation of the one of the first roller or the second roller coupled to the magnetic body.

22. The method according to claim 21, wherein:
a first main gear is coupled to the first roller,
a second main gear is coupled to the second roller,
a first sub-gear is rotated by the motor and is gear-fitted to the first main gear, and
a second sub-gear is gear-coupled to the second main gear and the first sub-gear,
controlling the motor to rotate the roller according to the calculated operation information includes controlling the motor to rotate the first sub-gear according to the calculated operation information, and
the first main gear, second sub-gear, and the second main gear are rotated based on the motor rotating the first sub-gear such that the first sub-gear and the second sub-gear rotate in different directions.
